(19) United States
(12) Patent Application Publication
(10) Pub. No.: US 2025/0118077 A1
(43) Pub. Date: Apr. 10, 2025

(54) SERVER APPARATUS, SYSTEM, CONTROL METHOD OF SERVER APPARATUS, AND STORAGE MEDIUM

(71) Applicant: NEC Corporation, Minato-ku, Tokyo (JP)

(72) Inventors: Haruka Kurose, Tokyo (JP); Takumi Otani, Tokyo (JP); Takeshi Sasamoto, Tokyo (JP)

(73) Assignee: NEC Corporation, Minato-ku, Tokyo (JP)

(21) Appl. No.: 18/730,863

(22) PCT Filed: Feb. 22, 2022
(86) PCT No.: PCT/JP2022/007391

§ 371 Date: Jul. 22, 2024

(51) Int. Cl. G06V 20/52; G06F 21/32; G07C 9/25

(52) U.S. Cl. CPC G06V 20/52; G06F 21/32; G07C 9/253; G07C 9/257

(57) ABSTRACT

A server apparatus includes a tracking unit and a notification unit. The tracking unit receives a video from a camera device and determines a user type of at least one or more users, the user type regarding a method of procedure to be proceeded with at an authentication terminal, who appear in images that forms the video. Furthermore, the tracking unit tracks a user whose the user type is determined using a video received from the camera device as a target person to be tracked. The notification unit notifies an external device of the user type of the target person to be tracked who appears in the video received from the camera device.

### TECHNICAL FIELD

The present invention relates to a server apparatus, a system, a control method of a server apparatus, and a storage medium.

### BACKGROUND ART

The development of technologies aimed at increasing convenience for airport users and improving operational efficiency within airports is underway.

For example, Patent Literature 1 describes that an information processing apparatus, an information processing method, and a program that can improve throughput in a procedure area where a procedure method using biometric authentication or a procedure method using an authentication method other than biometric authentication can be selected is provided. The information processing apparatus of Patent Literature 1 includes an acquisition unit, a matching unit, and a guidance unit. The acquisition unit acquires biometric information of a user in the procedure area where the user can select either a first method of performing identity verification using an automated lane using biometric authentication or a second method of performing identity verification in a face-to-face manner. The matching unit determines whether the user is a registered person or not by matching the biometric information with registered biometric information of the user who can use the first method. When the matching unit determines that the user is the registered person, the guidance unit generates guidance information that guides the user to a location for a procedure corresponding to the first method.

Patent Literature 2 describes that an object is to provide an information processing apparatus, an information processing method, and a recording medium that support a procedure of a passenger at a boarding gate apparatus. The information processing apparatus of Patent Literature 2 includes an acquisition unit, an identifying unit, and an output unit. The acquisition unit acquires biometric information of a passenger from a captured image of the passenger who boards an aircraft and has not yet passed through a boarding gate corresponding to the aircraft. The identifying unit identifies boarding reservation information regarding the passenger using the acquired biometric information. The output unit outputs information to support a procedure of the passenger at the boarding gate based on the identified boarding reservation information.

### CITATION LIST

### Literature

[PTL 1] Japanese Unexamined Patent Application Publication No. JP2021-163457
[PTL 2] International Publication WO2021/029046

### SUMMARY OF INVENTION

### Technical Problem

As disclosed in Patent Literature 1 and Patent Literature 2, procedures using biometric authentication have been performed at airports and the like. However, there also are users who choose to proceed with an existing procedure that does not use biometric authentication. In other words, users need to choose whether to proceed with a procedure using biometric authentication or in a manned lane where a staff member is stationed. Here, when a user makes a mistake in selecting a procedure method in the procedure area where the user can choose between a procedure method using biometric authentication and the existing procedure, throughput in the procedure area is reduced.

Note that this problem cannot be solved even by using the technologies disclosed in Patent Literature 1 and Patent Literature 2 above. In the technology disclosed in Patent Literature 1, the user is required to check guidance, and so on, displayed on a terminal by himself/herself, and there may be users who overlook the display of the terminal. In addition, the technology disclosed in Patent Literature 2 provides guidance regarding priority boarding by a passenger, which is different from guidance when the passenger passes through the boarding gate.

It is a main object of the present invention to provide a server apparatus, a system, a control method for a server apparatus, and a storage medium that contribute to improving throughput in a procedure area where a user can proceed with a procedure using different methods.

### Solution to Problem

According to a first aspect of the present invention, there is provided a server apparatus, including: a tracking unit that receives a video from a camera device, determines a user type of at least one or more users, the user type regarding a method of procedure to be proceeded with at an authentication terminal, who appear in images that forms the video, and tracks a user whose the user type is determined using a video received from the camera device as a target person to be tracked; and a notification unit that notifies an external device of the user type of the target person to be tracked who appears in the video received from the camera device.

According to a second aspect of the present invention, there is provided a system, comprising: a camera device; and a server apparatus, wherein the server apparatus comprises: a tracking unit that receives a video from the camera device, determines a user type of at least one or more users, the user type regarding a method of procedure to be proceeded with at an authentication terminal, who appear in images that forms the video, and tracks a user whose the user type is determined using a video received from the camera device as a target person to be tracked; and a notification unit that notifies an external device of the user type of the target person to be tracked who appears in the video received from the camera device.

According to a third aspect of the present invention, there is provided a control method of a server apparatus, the control method comprising: receiving a video from a camera device, determining a user type of at least one or more users, the user type regarding a method of procedure to be proceeded with at an authentication terminal, who appear in images that forms the video, and tracking a user whose the user type is determined using a video received from the camera device as a target person to be tracked; and notifying an external device of the user type of the target person to be tracked who appears in the video received from the camera device.

According to a fourth aspect of the present invention, there is provided a computer-readable storage medium storing a program causing a computer mounted on a server apparatus to perform processing for: receiving a video from a camera device, determining a user type of at least one or more users, the user type regarding a method of procedure to be proceeded with at an authentication terminal, who appear in images that forms the video, and tracking a user whose the user type is determined using a video received from the camera device as a target person to be tracked; and notifying an external device of the user type of the target person to be tracked who appears in the video received from the camera device.

### Advantageous Effects of Invention

The individual aspects of the present invention to provide a server apparatus, a system, a control method for a server apparatus, and a storage medium that contribute to improving throughput in a procedure area where a user can proceed with a procedure using different methods. The advantageous effect of the present invention is not limited to the above advantageous effect. The present invention may provide other advantageous effects, instead of or in addition to the above advantageous effect.

### BRIEF DESCRIPTION OF THE DRAWINGS

FIG. 1 is a diagram illustrating an outline of an example embodiment.

FIG. 2 is a flowchart illustrating an operation of an example embodiment.

FIG. 3 is a diagram illustrating an example of a schematic configuration of an airport management system according to a first example embodiment.

FIG. 4 is a diagram illustrating an operation of the airport management system according to the first example embodiment.

FIG. 5 is a diagram illustrating an operation of the airport management system according to the first example embodiment.

FIG. 6 is a diagram illustrating a configuration of the airport management system according to the first example embodiment.

FIG. 7 is a diagram illustrating an operation of the airport management system according to the first example embodiment.

FIG. 8 is a diagram illustrating an example of a processing configuration of a check-in terminal according to the first example embodiment.

FIG. 9 is a diagram illustrating an example of a processing configuration of a boarding gate apparatus according to the first example embodiment.

FIG. 10 is a diagram illustrating an example of a processing configuration of a server apparatus according to the first example embodiment.

FIG. 11 is a diagram illustrating an example of a registered person information database according to the first example embodiment.

FIG. 12 is a flowchart illustrating an example an operation of a tracking unit according to the first example embodiment.

FIG. 13 is a diagram illustrating an example of a target person to be tracked management database according to the first example embodiment.

FIG. 14 is a diagram illustrating an operation of a user type notification unit according to the first example embodiment.

FIG. 15 is a sequence diagram illustrating an example of an operation of the airport management system according to the first example embodiment.

FIG. 16 is a diagram illustrating a configuration of the airport management system of a variation 1 according to the first example embodiment.

FIG. 17 is a diagram illustrating a configuration of the airport management system of a variation 2 according to the first example embodiment.

FIG. 18 is a diagram illustrating an operation of the airport management system of the variation 2 according to the first example embodiment.

FIG. 19 is a diagram illustrating a configuration of the airport management system of the variation 2 according to the first example embodiment.

FIG. 20 is a diagram illustrating a configuration of an airport management system according to a second example embodiment.

FIG. 21 is a flowchart illustrating an example of an operation of a tracking unit according to the second example embodiment.

FIG. 22 is a diagram illustrating an example of table information included in a server apparatus according to the second example embodiment.

FIG. 23 is a diagram illustrating an example of a target person to be tracked management database according to the second example embodiment.

FIG. 24 is a diagram illustrating an operation of a user type notification unit according to the second example embodiment.

FIG. 25 is a diagram illustrating an operation of the user type notification unit of a variation according to the second example embodiment.

FIG. 26 is a diagram illustrating an example of the hardware configuration of the server apparatus of the present application.

FIG. 27 is a diagram illustrating an example of a schematic configuration of the airport management system according to the variation of the present application.

### EXAMPLE EMBODIMENT

First, an outline of an example embodiment will be described. In the following outline, various components are denoted by reference characters for the sake of convenience. That is, the following reference characters are used as examples to facilitate the understanding of the present invention. Thus, the description of the outline is not intended to impose any limitations. In addition, unless otherwise specified, an individual block illustrated in the drawings represents a configuration of a functional unit, not a hardware unit. An individual connection line between blocks in the drawings signifies both one-way and two-way directions. An arrow schematically illustrates a principal signal (data) flow and does not exclude bidirectionality. In the present description and drawings, elements that can be described in a like way will be denoted by a like reference character, and redundant description thereof will be omitted as needed.

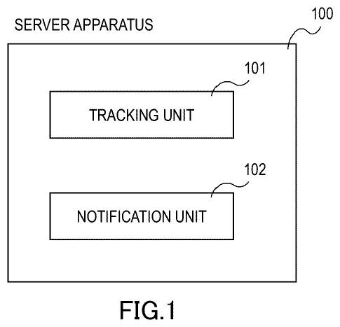

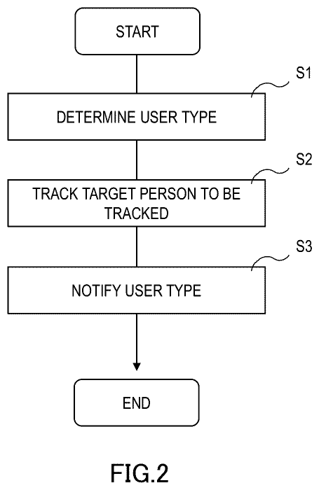

A server apparatus 100 according to an example embodiment includes a tracking unit 101 and a notification unit 102 (see FIG. 1). The tracking unit 101 receives a video from a camera device and determines a user type of at least one or more users, the user type regarding a method of procedure to be proceeded with at an authentication terminal, who appear in images that forms the video (step S1 in FIG. 2). Furthermore, the tracking unit 101 tracks a user whose the user type is determined using a video received from the camera device as a target person to be tracked (step S2). The notification unit 102 notifies an external device of the user type of the target person to be tracked who appears in the video received from the camera device (Step S3).

The server apparatus 100 acquires the video that captures an image of the user who is heading to the authentication terminal installed at the procedure area, and notifies the external device of the user type of the user in the video (for example, a user who can or cannot perform the procedure with biometric authentication). For example, the server apparatus 100 transmits a video that reflects the user type to a display device installed at the procedure area. A staff member who guides the user to use a correct authentication terminal can check a display content of the display device. While the staff member checks the video output by the display device, the staff member finds a user who is heading to a wrong authentication terminal before the user in the procedure area arrives at the authentication terminal, and guides the user to a correct authentication terminal. As a result, since each user can perform the procedure at the authentication terminal that matches a method of procedure he or she has selected, thereby eliminating failures caused by the user who has performed the procedure at the authentication terminal corresponding to a wrong procedure. In other words, since the number of failed procedures at the authentication terminal in the procedure area is reduced, throughput in the procedure area (the number of users that can be processed by the authentication terminal) is increased.

Hereinafter, specific example embodiments will be described in more detail with reference to drawings.

### First Example Embodiment

A first example embodiment will be described in more detail with reference to drawings.

### System Configuration

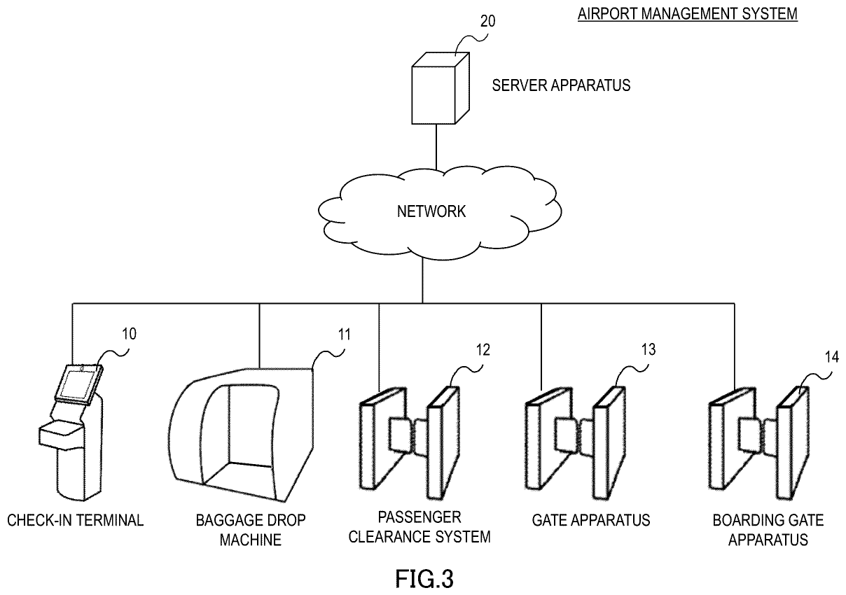

FIG. 3 is a diagram illustrating an example of a schematic configuration of an airport management system (information processing system) according to the first example embodiment. The airport management system shown in FIG. 3 is operated, for example, by a public organization such as an immigration bureau, or a contractor who is commissioned by the public organization to perform business. For example, the airport management system manages a series of procedures (baggage check-in, security check, and so on) at an airport.

Referring to FIG. 3, the airport management system includes a check-in terminal 10, a baggage drop machine 11, a passenger clearance system 12, a gate apparatus 13, a boarding gate apparatus 14, and a server apparatus 20.

The baggage drop machine 11, the passenger clearance system 12, the gate apparatus 13, and the boarding gate apparatus 14 are authentication terminals (touch points) installed at the airport. The authentication terminals and the check-in terminal 10 are connected to the server apparatus 20 via a network. The network shown in FIG. 3 consists of a LAN (Local Area Network) that includes a premises communication network of the airport, a WAN (Wide Area Network), a mobile communication network, and so on. A connection method is not limited to a wired method and may be a wireless method.

The server apparatus 20 is an apparatus that realizes a main function of the airport management system. The server apparatus 20 is installed in a facility of an airport company or airline company, and so on. Alternatively, the server apparatus 20 may be a server located in a cloud on a network.

Note that the configuration shown in FIG. 3 is an example and is not intended to limit the configuration of the airport management system. The airport management system may include a terminal or the like, which are not shown in the drawings.

### Schematic Operation of System

Boarding procedure for a user includes check-in, baggage drop-off, security check, emigration inspection, boarding pass verification, and so on.

The user (passenger) can proceed through the above boarding procedure using biometric authentication or using a method that does not use the biometric authentication. When the boarding procedure is performed using the biometric authentication, the above-mentioned series of boarding procedures is carried out sequentially at terminals installed at five locations.

The check-in terminal 10 is installed at a check-in lobby in the airport. The check-in terminal 10 is also a self-service terminal for a check-in procedure through operation by the user. The check-in terminal 10 is also referred to as a CUSS (Common Use Self Service) terminal.

When a user (passenger) arrives at the airport, the user operates the check-in terminal 10 and performs a “check-in procedure”. The user presents a paper airline ticket, a two-dimensional barcode which describes boarding information, a mobile terminal which displays a copy of the e-ticket, and the like to the check-in terminal 10. The check-in terminal 10 outputs a boarding pass when the check-in procedure is completed. Note that the boarding pass includes both a paper boarding pass and an electronic boarding pass.

The user who has completed the check-in procedure and wishes to proceed with boarding using biometric authentication performs system registration using the check-in terminal 10. Specifically, the user reads the issued boarding pass and a passport into the check-in terminal 10. The check-in terminal 10 also acquires biometric information of the user. Note that the user who can perform system registration is limited to a user who possesses a passport that complies with a predetermined standard.

Note that examples of the biometric information include data (feature values) calculated from physical features unique to an individual, such as a face, a fingerprint, a voiceprint, a vein, a retina, or an iris pattern of an eye. Alternatively, the biometric information may be image data such as a face image, a fingerprint image, and so on. The biometric information may be anything that includes physical characteristics of a user as information. In the present application, a case in which biometric information about a “face” of a person (a face image or a feature value generated from the face image) is used will be described.

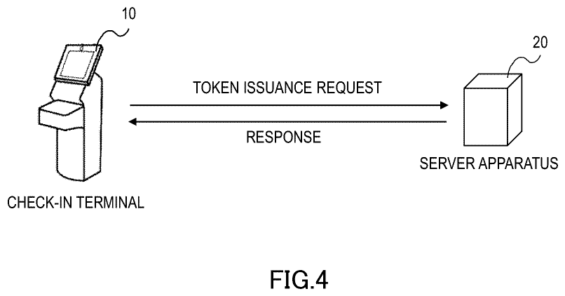

The check-in terminal 10 transmits information regarding the boarding pass, passport, and biometric information to the server apparatus 20. Specifically, the check-in terminal 10 transmits a “token issuance request” that includes information described in the boarding pass (boarding pass information), information described in the passport (passport information), and the biometric information (for example, a face image) to the server apparatus 20 (see FIG. 4).

The server apparatus 20 performs an identity verification using the biometric information described in the passport and the biometric information acquired by the check-in terminal 10. The server apparatus 20 determines whether a face image recorded on the passport and a face image captured by the check-in terminal 10 substantially match.

The server apparatus 20 determines that the identity verification of the user who presented his or her passport to the check-in terminal 10 is successful when the two face images (biometric information) substantially match.

When the identity verification is successful, the server apparatus 20 performs system registration for the user to proceed with the procedure using biometric authentication. Specifically, the server apparatus 20 issues a token to be used for the boarding procedures of the user whose identity verification has been completed.

The issued token is identified by a token ID (Identifier). Information necessary for the boarding procedure (for example, biometric information, operation information necessary for the boarding procedure, and so on) is associated with each other via the token ID. In other words, the “token ID” is issued with system registration of the user and is identification information for the user to undergo the boarding procedure using biometric information. Once the token (token ID) is issued, the user of the system can use the boarding procedure using biometric authentication.

In response to the issuance of the token, the server apparatus 20 adds an entry to a registered person information database that stores detailed information about the token that the server apparatus 20 generated. Details of the registered person information database will be described below.

When the identity verification fails, the server apparatus 20 refuses (rejects) the issuance of the token from the check-in terminal 10.

Once the token is issued (once the user has completed the system registration to proceed procedure using biometric authentication), the user can proceed with the boarding procedure on his/her own (without assistance of an airport staff member, or the like) using the authentication terminal (for example, the baggage drop machine 11, and so on).

Note that a user who wishes to proceed with conventional boarding procedure that does not require biometric authentication may check-in using the check-in terminal 10, or may check-in at a counter where an airline staff member or the like is waiting.

After the user has completed the check-in procedure, the user moves to a baggage drop-off area or a security checkpoint.

In the following descriptions, a user who has been registered in the system for performing boarding procedure using biometric authentication will be referred to as a “registered person in system” or simply as a “registered person”. Additionally, a user who has not been registered in the system for performing boarding procedure using biometric authentication will be referred to as a “non-registered person in system” or simply “non-registered person”.

A user who has completed the check-in procedure (registered person in system or non-registered person in system) checks his or her baggage, which cannot be carried on board, at the baggage drop-off area.

The registered person uses the baggage drop machine 11 to check in his or her baggage. The baggage drop machine 11 is installed in an area adjacent to a baggage counter (manned counter) in the airport or in the vicinity of the check-in terminal 10. The baggage drop machine 11 is a self-service terminal for the registered person to check in baggage that will not be carried on an aircraft (baggage check-in procedure). The baggage drop machine 11 is also referred to as a CUBD (Common Use Bag Drop) terminal. After the registered person has completed the baggage check-in procedure, the registered person moves to the security checkpoint.

The non-registered person checks his or her baggage with an airline staff member or the like. After the non-registered person has completed the baggage check-in procedures, the non-registered person moves to the security checkpoint. Note that when the user (registered person or non-registered person) does not check baggage, the baggage check-in procedure is omitted.

A user (registered person in system or non-registered person in system) undergoes a security check at the passenger clearance system 12 installed at the security checkpoint.

The passenger clearance system 12 is a gate apparatus installed at an entrance of the security checkpoint in the airport. The passenger clearance system 12, also referred to as the PRS (Passenger Reconciliation System), is a system that determines whether or not the user can pass through the security checkpoint at the entrance of the security checkpoint. After the user has completed the security check procedure by passing through the passenger clearance system 12, the user moves to an emigration inspection area.

The registered person who has passed the security check without any problem can pass directly through the gate apparatus installed at the security checkpoint. On the other hand, the non-registered person is required to present his or her boarding pass and so on to a security inspector even if there is no problem with the result of the security check.

A user (registered person in system or non-registered person in system) undergoes emigration inspection at the departure inspection area.

The registered person undergoes emigration examination at the gate apparatus 13. The gate apparatus 13 is installed at the emigration examination area in the airport. The gate apparatus 13 is an apparatus that automatically performs an emigration examination procedure for the registered person. After the registered person has completed the emigration examination procedure, the registered person moves to a departure area where a duty-free store and boarding gate are located.

The non-registered person undergoes the emigration examination by an emigration and immigration inspector. After the non-registered person has completed the emigration examination procedure, the non-registered person moves to the departure area.

The user (registered person in system or non-registered person in system) moves through the boarding gate apparatus 14 installed in the departure area and moves to a boarding gate.

The registered person passes through the boarding gate apparatus 14 where no airline staff member is waiting nearby. The non-registered person passes through the boarding gate apparatus 14 where an airline staff member is waiting nearby.

The boarding gate apparatus 14 that controls passage of the registered person determines whether or not the registered person can board the aircraft. When the boarding gate apparatus 14 determines that the registered person can board the aircraft, the boarding gate apparatus 14 opens a gate and permits the registered person to pass through the gate.

The non-registered person hands over the passport in his or her possession to the staff member waiting near boarding gate apparatus 14. The staff member performs identity verification using the passport, and when the identity verification is successful, the boarding pass is loaded into the boarding gate apparatus 14. When the boarding gate apparatus 14 determines that the non-registered person can board the aircraft using information acquired from the boarding pass, the boarding gate apparatus 14 opens the gate and permits the non-registered person to pass through.

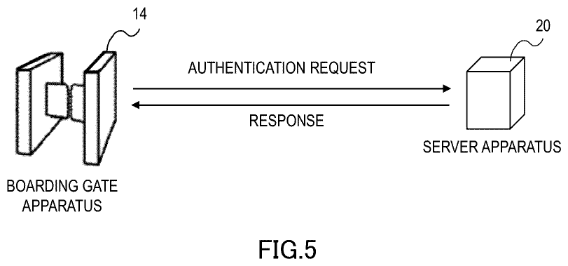

Note that when the registered person in system who has been issued a token arrives at the authentication terminal (for example, the boarding gate apparatus 14), biometric information (for example, a face image) is acquired at the authentication terminal. The authentication terminal transmits an authentication request that includes the biometric information to the server apparatus 20 (see FIG. 5).

The server apparatus 20 identifies the token (entry) by performing a matching processing (1-to-N matching; N is a positive integer, and the same applies to the following description) using the biometric information acquired from the authentication terminal and the biometric information registered in the system. The boarding process for the user is carried out based on operation information associated with the identified token. For example, the server apparatus 20 transmits boarding pass information of the user identified by the matching process to the boarding gate apparatus 14.

The boarding gate apparatus 14 determines whether or not the user (registered person in system) is permitted to pass through based on the received boarding pass information. Specifically, the boarding gate apparatus 14 determines whether or not the user is permitted to pass through based on whether or not the airline code and flight number set by the staff member, or the like in own apparatus and an airline code and flight number in the boarding pass information acquired from the server apparatus 20 match or not. When the airline codes, and so on match, the user is permitted to pass through, and when the airline codes, and so on do not match, the user is rejected to pass through.

As described above, the registered person in system (the user who proceeds with the procedure using biometric authentication) can proceed with the procedure independently at each procedure area such as baggage drop-off area, security checkpoint, emigration inspection area, and departure area. On the other hand, the non-registered person in system (the user who proceeds with the procedure without using biometric authentication) proceeds with the procedure with the staff member, security inspector, emigration and immigration inspector, or the like waiting at each procedure area such as baggage drop-off area, security checkpoint, emigration inspection area, and departure area.

Since passengers using the airport include both registered persons in system and non-registered persons in system, it is necessary to install apparatuses (terminals, facilities) for the registered person and an apparatus for the non-registered person at each procedure area, such as emigration inspection area and departure area. Furthermore, the user (registered person or non-registered person) needs to use an apparatus that corresponds to the method the user has selected (procedure using biometric authentication or procedure without using biometric authentication).

For example, in the departure area, the registered person can pass through the boarding gate apparatus 14 using biometric authentication and therefore needs to go to the boarding gate apparatus 14 where no staff member is waiting. More specifically, the registered person needs to line up in a lane of the boarding gate apparatus 14 that is compatible with biometric authentication.

On the other hand, the non-registered person cannot pass through the boarding gate apparatus 14 using biometric authentication and therefore needs to go to the boarding gate apparatus 14 where a staff member is waiting. More specifically, the non-registered person needs to line up in the lane of the boarding gate apparatus 14 that is not compatible with biometric authentication.

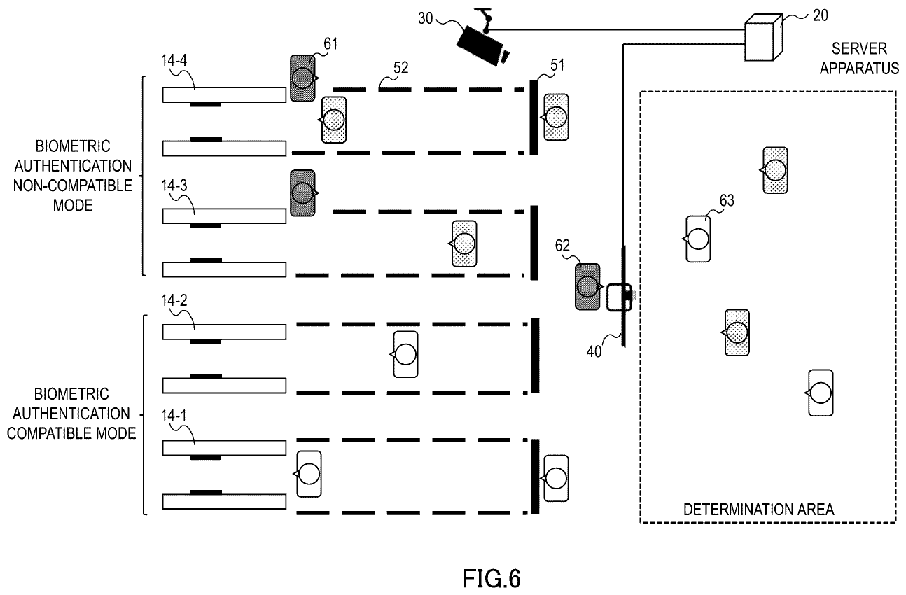

The above situation will be described in more detail with reference to FIG. 6.

As shown in FIG. 6, users (registered person in system and non-registered person in system) move to the departure area where the boarding gate apparatuses 14 are installed. In the departure area, the boarding gate apparatuses 14 that are compatible with biometric authentication and the boarding gate apparatuses 14 that are not compatible with biometric authentication are installed. For more details, the boarding gate apparatus 14-1 and boarding gate apparatus 14-2 are compatible with biometric authentication, while the boarding gate apparatus 14-3 and boarding gate apparatus 14-4 are not compatible with biometric authentication.

A stop line 51 is drawn in front of each of the boarding gate apparatuses 14. The users wait in front of the stop line 51 until a previous user finishes procedure. When the previous user finishes the procedure, the users who have been waiting go to the boarding gate apparatus 14 installed in front of the users to perform the procedure.

The registered person in system goes to the boarding gate apparatus 14-1 or boarding gate apparatus 14-2 that is compatible with biometric authentication. The boarding gate apparatus 14-1 or boarding gate apparatus 14-2 acquires biometric information of the user in front of the boarding gate apparatus 14-1 or boarding gate apparatus 14-2 and transmits an authentication request that includes the acquired biometric information to the server apparatus 20. When the authentication is successful, the server apparatus 20 transmits boarding pass information of the user to the boarding gate apparatus 14-1 or boarding gate apparatus 14-2. The boarding gate apparatuses 14-1 or boarding gate apparatus 14-2 determine whether the user is eligible to board an aircraft or not based on the acquired boarding pass information. When the user is eligible to board the aircraft, the boarding gate apparatus 14-1 or boarding gate apparatus 14-2 opens a gate and permits the user (the person to be authenticated) to pass through.

The non-registered person in system goes to the boarding gate apparatus 14-3 or boarding gate apparatus 14-4 that are not compatible with biometric authentication. The user hands over his or her passport and boarding ticket to an airline staff member 61 (dark gray figure) who is waiting near the boarding gate apparatus 14-3 or boarding gate apparatus 14-4. The staff member 61 performs identity verification by comparing a passport photo with a face of the user in front of the staff member 61.

When the identity verification is successful, the staff member 61 causes the boarding gate apparatus 14-3 or boarding gate apparatus 14-4 to read the boarding pass handed over to the staff member 61 by the user. The boarding gate apparatus 14-3 or boarding gate apparatus 14-4 determines whether or not the user is eligible to board the aircraft based on the information on the read boarding pass. When the user is eligible to board the aircraft, the boarding gate apparatus 14-3 or boarding gate apparatus 14-4 opens the gate and permits the user to pass through.

As shown in FIG. 6, a fence 52 is installed between each of the boarding gate apparatuses 14 and the stop line 51, and the users who line up in front of the stop line 51 cannot move to other lanes.

The users (registered person in system or non-registered person in system) who have moved to the departure area walk toward the boarding gate apparatuses 14 from the right side of the drawing. At that time, the users need to line up in the lanes of boarding gate apparatuses 14 corresponding to the method the users have selected (procedure using biometric authentication or procedure without using biometric authentication).

At that time, users who are clearly aware of the method the users have selected grasp the lanes in which the users will line up. However, some users who are not clearly aware of the method they have selected are included. For example, in FIG. 6, users in white indicate the “registered persons in system” who have registered with the system, and users in light gray indicate the “non-registered persons in system” who have not registered with the system.

The registered persons in system in white needs to line up in front of the boarding gate apparatus 14-1 or boarding gate apparatus 14-2, which are compatible with biometric authentication. On the other hand, the non-registered persons in system in light gray need to line up in front of the boarding gate apparatus 14-3 or boarding gate apparatus 14-4, which are not compatible with biometric authentication.

If each user does not line up in the correct boarding gate apparatus 14 (the boarding gate apparatus 14 corresponding to the method selected by the user), a user who lines up in the wrong lane will not be able to pass through the boarding gate apparatus 14, thus impeding smooth procedure.

Specifically, the airline staff member has to explain to the user who cannot pass through the boarding gate apparatus 14 the reason why the user cannot pass through the gate, and ask the user to line up again in the correct lane after the user agrees with the reason, and so on. When such handling occurs, the throughput of the boarding gate apparatuses 14 (especially the throughput of the boarding gate apparatus 14-1 and boarding gate apparatus 14-2, which are compatible with biometric authentication and allow the users to walk through) is decreased.

Therefore, the airline staff member 62 provides guidance to the users who have moved to the departure area so that the users can line up in the appropriate lane. Specifically, the staff member 62, while watching an image (video) displayed on a display device 40, finds out a user who is attempting to line up in the wrong lane, and provides guidance (guidance by voice) to the user so that the user can line up in the correct lane.

A camera device 30 is installed to realize the guidance. The camera device 30 is installed on the ceiling of the departure area or the like. The camera device 30 is installed so that the camera device 30 can capture images of the users who are heading to the boarding gate from the departure area.

The camera device 30 transmits to the server apparatus 20 a captured video of the area indicated by the dotted line (determination area). The server apparatus 20 determines whether the users in the departure area are the registered persons in system or the non-registered persons in system using the video acquired from the camera device 30. In other words, the server apparatus 20 determines a user type (registered person in system or non-registered person in system).

In the following description, the determination of the user type (registered person in system, non-registered person in system) will be described as “user type determination”.

The server apparatus 20 reflects the result of the above user type determination (registered person in system, non-registered person in system) in the video acquired from the camera device 30, and transmits the video in which the result of determination is reflected to the display device 40.

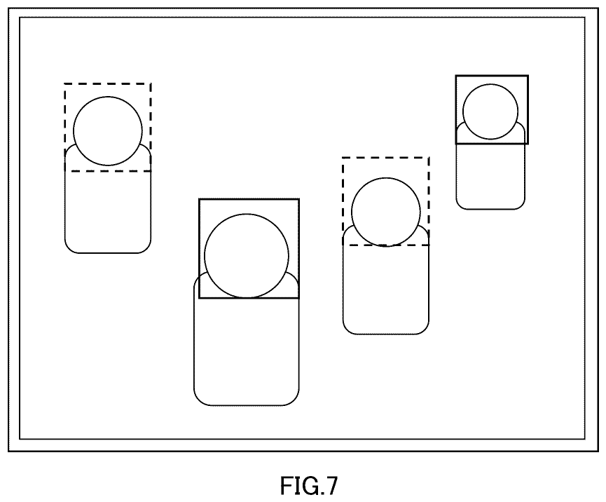

The display device 40 displays the acquired video (the video that reflects the result of determination of whether or not the user is the registered person in system). For example, the display device 40 performs the display as shown in FIG. 7.

The server apparatus 20 reflects the above result of user type determination in the video received from the camera device 30 in a manner that allows the staff member 62 to instantly grasp whether a person in the video is the registered person in system or the non-registered person in system.

For example, as shown in FIG. 7, the server apparatus 20 generates image data in which a face area of the registered person in system is surrounded by a solid frame and a face area of the non-registered person in system is surrounded by a dotted line. Alternatively, the server apparatus 20 may change a tone (color) of the frame surrounding the face area of each user, so that the registered person in system and the non-registered person in system can be displayed in a distinguishable manner.

In this way, the server apparatus 20 acquires the video from the camera device 30 and determines the method of procedure (procedure using biometric authentication or procedure without using biometric authentication) selected by the person in the video. The server apparatus 20 reflects the result of determination in the video in real time and transmits the video on which the result of determination is reflected to the display device 40.

While watching the video output by the display device 40, the staff member 62 finds the user who is attempting to line up in the wrong lane and provides guidance to the user to the correct lane. In the example in FIG. 6, when a user 63 who can proceed with the procedure using biometric authentication attempts to line up at the upper boarding gate apparatus 14-3 or boarding gate apparatus 14-4, the staff member 62 calls out to the user 63 and guides the user 63 to the correct lane (boarding gate apparatus 14-1 or boarding gate apparatus 14-2).

Here, the server apparatus 20 tracks the user from the departure area to the boarding gate in order to reflect the result of determination of user type in the video in real time. Specifically, the range indicated by the dotted line in FIG. 6 (range that can be captured by the camera device 30) is set as a determined area, and the user who enters the determined area is treated as a target person to be tracked.

When the user enters the determination area, the server apparatus 20 determines whether or not the user is the registered person in system. Moreover, the server apparatus 20 sets the user as the target person to be tracked and generates identification information (personal identification number) that identifies the target person to be tracked.

The server apparatus 20 stores the personal identification number, the face image of the user, and the result of determination (the user is the registered person in system or non-registered person in system), and so on, in association with each other. When the server apparatus 20 successfully tracks the user using the video acquired from the camera device 30, the server apparatus 20 reflects the result of determination of the user (registered person in system or non-registered person in system) in the video.

The server apparatus 20 transmits the video (the image data as shown in FIG. 7) reflecting the result of determination to the display device 40.

Next, details of the individual apparatuses included in the airport management system according to the first example embodiment will be described.

### Check-in Terminal

As described above, the check-in terminal 10 is an apparatus that provides operations regarding the check-in procedure and the system registration to a user of the system.

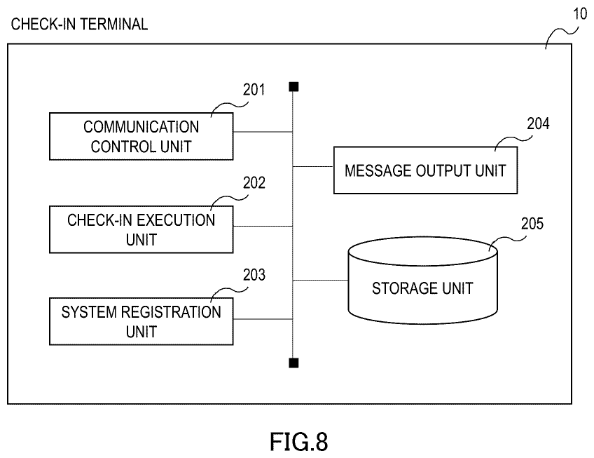

FIG. 8 is a diagram illustrating an example of a processing configuration (processing modules) of the check-in terminal 10 according to the first example embodiment. Referring to FIG. 8, the check-in terminal 10 includes a communication control unit 201, a check-in execution unit 202, a system registration unit 203, a message output unit 204, and a storage unit 205.

The communication control unit 201 is means for controlling communication with other apparatuses. For example, the communication control unit 201 receives data (packets) from the server apparatus 20. In addition, the communication control unit 201 transmits data to the server apparatus 20. The communication control unit 201 gives data received from other apparatuses to other processing modules. The communication control unit 201 transmits data acquired from other processing modules to other apparatuses. In this way, other processing modules transmit and receive data to and from other apparatuses via the communication control unit 201. The communication control unit 201 includes a function as a receiving unit that receives data from other apparatuses and a function as a transmitting unit that transmits data to other apparatuses.

The check-in execution unit 202 is means for performing the check-in procedure for a user. The check-in execution unit 202 executes the check-in procedure such as seat selection, and so on based on an airline ticket presented by the user. For example, the check-in execution unit 202 transmits information described on the airline ticket to a DCS (Departure Control System) and acquires information to be described on boarding pass from the DCS. Note that an operation of the check-in execution unit 202 can be the same as that of an existing check-in terminal, so a more detailed explanation will be omitted.

The system registration unit 203 is means for performing system registration of a user who wishes to undergo the boarding procedure using biometric authentication. For example, the system registration unit 203 displays a GUI (Graphical User Interface) to confirm whether or not the user wishes to use the “boarding procedure using a face image” after the check-in procedure is completed.

When a user wishes to register with the system, the system registration unit 203 acquires the three pieces of information (boarding pass information, passport information, and biometric information) using a GUI for acquiring the three pieces of information. The system registration unit 203 acquires the boarding pass information and passport information from the boarding pass and passport held by the user. The system registration unit 203 controls a reader such as a scanner (not shown) and acquires the information described on the boarding pass (boarding pass information) and the information described on the passport (passport information).

The boarding pass information includes name (first name, last name), airline code, flight number, boarding date, place of departure (boarding airport), destination (arrival airport), seat number, boarding time, arrival time, and so on. The passport information includes passport face image, name, gender, nationality, passport number, passport issuing country, and so on.

Moreover, the system registration unit 203 acquires biometric information of a user. The system registration unit 203 controls a camera and acquires the face image of the user. For example, when the system registration unit 203 detects a face in the image that is constantly or periodically captured, the system registration unit 203 captures the face of the user and acquires the face image of the user.

After that, the system registration unit 203 generates a token issuance request that includes the acquired three pieces of information (boarding pass information, passport information, and biometric information).

For example, the system registration unit 203 generates the token issuance request that includes an identifier of the own device (hereinafter referred to as “terminal ID”), the boarding pass information, the passport information, and the biometric information. Note that a MAC (Media Access Control) address or an IP (Internet Protocol) address of the check-in terminal 10 can be used as the terminal ID. The system registration unit 203 transmits the generated token issuance request to the server apparatus 20.

The system registration unit 203 hands over the response acquired from the server apparatus 20 (response to the token issuance request) to the message output unit 204.

The message output unit 204 is means for outputting various messages. For example, the message output unit 204 outputs a message in accordance with the response acquired from the server apparatus 20.

When the message output unit 204 receives a response (positive response) that the token has been successfully issued, the message output unit 204 outputs a message to that effect. For example, the message output unit 204 outputs a message such as “Future procedures can be performed using face recognition”.

When the message output unit 204 receives a response (negative response) that the token has failed to be issued, the message output unit 204 outputs a message to that effect. For example, the message output unit 204 outputs a message “We are sorry. You cannot proceed with the procedure using face recognition. Please head to a manned booth.”.

The storage unit 205 is means for storing information necessary for the operation of the check-in terminal 10.

### Boarding Gate Apparatus

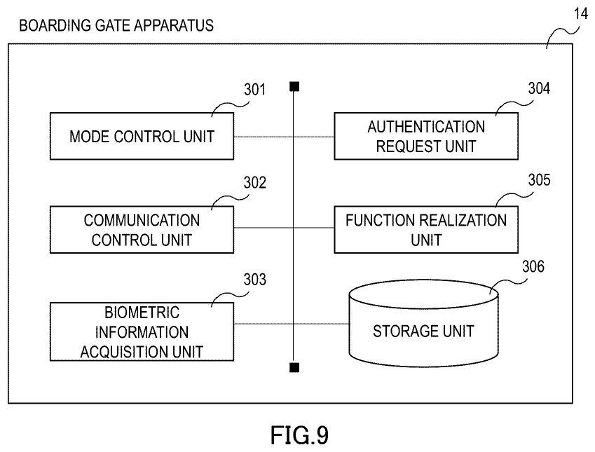

FIG. 9 is a diagram illustrating an example of a processing configuration (processing modules) of the boarding gate apparatus 14 according to the first example embodiment. Referring to FIG. 9, the boarding gate apparatus 14 includes a mode control unit 301, a communication control unit 302, a biometric information acquisition unit 303, an authentication request unit 304, a function realization unit 305, and a storage unit 306.

The mode control unit 301 is means for controlling a mode of operation of the boarding gate apparatus 14. The mode control unit 301 acquires the mode of operation (biometric authentication compatible mode, biometric authentication non-compatible mode, or power off mode) in accordance with a status of a switch attached to the boarding gate apparatus 14. Alternatively, the mode control unit 301 may acquire the mode of operation using a GUI (Graphical User Interface) displayed on a liquid crystal panel or the like.

In the example in FIG. 6, the biometric authentication compatible mode is set for the boarding gate apparatus 14-1 and 14-2. The biometric authentication non-compatible mode is set for the boarding gate apparatus 14-3 and boarding gate apparatus 14-4.

First, each module of the boarding gate apparatus 14 set to the biometric authentication compatible mode will be described.

The communication control unit 302 is means for controlling communication with other apparatuses. For example, the communication control unit 302 receives data (packets) from the server apparatus 20. In addition, the communication control unit 302 transmits data to the server apparatus 20. The communication control unit 302 gives data received from other apparatuses to other processing modules. The communication control unit 302 transmits data acquired from other processing modules to other apparatuses. In this way, other processing modules transmit and receive data to and from other apparatuses via the communication control unit 302. The communication control unit 302 includes a function as a receiving unit that receives data from other apparatuses and a function as a transmitting unit that transmits data to other apparatuses.

The biometric information acquisition unit 303 is means for controlling a camera (not shown) and acquiring biometric information of a user (person to be authenticated). The biometric information acquisition unit 303 captures an image in front of own apparatus periodically or at predetermined timing. The biometric information acquisition unit 303 determines whether or not the acquired image includes a human face image, and when the face image is included, extracts the face image from the acquired image data.

An existing technique can be used for the face image detection and extraction processing performed by the biometric information acquisition unit 303, and therefore, detailed description thereof will be omitted. For example, the biometric information acquisition unit 303 may extract a face image (a face area) from the image data by using a learning model learned by a CNN (Convolutional Neural Network). Alternatively, the biometric information acquisition unit 303 may extract a face image by using a technique such as template matching.

The biometric information acquisition unit 303 gives the extracted face image to the authentication request unit 304.

The authentication request unit 304 is means for requesting the server apparatus 20 for an authentication regarding the user in front. The authentication request unit 304 generates an authentication request that includes the acquired face image and transmits the authentication request to the server apparatus 20.

The authentication request unit 304 receives a response from the server apparatus 20 to the authentication request.

The authentication request unit 304 hands over the result of authentication (authentication success or authentication failure) acquired from the server apparatus 20 to the function realization unit 305. When the authentication is successful, the authentication request unit 304 also hands over “operation information” acquired from the server apparatus 20 to the function realization unit 305.

The function realization unit 305 is means for realizing a “control of passage of user” function of the boarding gate apparatus 14.

When the result of authentication is “authentication failure”, the function realization unit 305 notifies the user (the person who has failed authentication; the person to be authenticated who is determined to have failed in authentication) to that effect. In addition, the function realization unit 305 closes a flapper, gate, and so on, and rejects the user to pass through.

In case of successful authentication, the function realization unit 305 acquires the airline code, flight number, and so on that are described on the boarding pass issued to the user from the acquired operation information (boarding pass information). The function realization unit 305 determines whether the airline code and flight number preset in own apparatus by an airline staff member, or the like, and the airline code and flight number acquired from the server apparatus 20 match or do not match.

When the airline code, and so on, match, the function realization unit 305 permits the user (registered person in system) to pass through the gate. The function realization unit 305 opens the flapper, gate, and so on, and permits the user to pass through.

When the airline code, and so on, do not match, the function realization unit 305 rejects the user to pass through the gate. The function realization unit 305 closes the flapper, gate, and so on, and rejects the user to pass through.

The storage unit 306 is means for storing information necessary for the operation of the boarding gate apparatus 14.

Next, each module of boarding gate apparatus 14 set to biometric authentication non-compatible mode will be described.

In the biometric authentication non-compatible mode, the communication control unit 302, the biometric information acquisition unit 303, and the authentication request unit 304 do not operate. In the biometric authentication non-compatible mode, the function realization unit 305 mainly operates.

The function realization unit 305 in the biometric authentication non-compatible mode controls a card reader and reads information described on the boarding pass. Specifically, the function realization unit 305 reads boarding pass information (airline code, flight number, and so on) from the boarding pass handed over to the airline staff member from the user.

The function realization unit 305 determines whether the airline code described in the read boarding pass matches an airline code and flight number preset in own apparatus by the airline staff member or the like.

When the airline code, and so on, match, the function realization unit 305 permits the user to pass through the gate. The function realization unit 305 opens the flapper, gate, and so on, and permits the user to pass through.

When the airline code, and so on, do not match, the function realization unit 305 rejects the user to pass through the gate. The function realization unit 305 closes the flapper, gate, and so on, and rejects the user to pass through the gate.

### Other Authentication Terminals

Basic processing configuration of the other authentication terminals (the baggage drop machine 11, the passenger clearance system 12, and the gate apparatus 13) included in the airport management system can be the same as the processing configuration of the boarding gate apparatus 14 shown in FIG. 9, so a detailed description will be omitted. Each terminal acquires biometric information (face image) of the person to be authenticated and requests an authentication using the acquired biometric information to the server apparatus 20. When the authentication is successful, the functions assigned to each terminal are executed.

### Server Apparatus

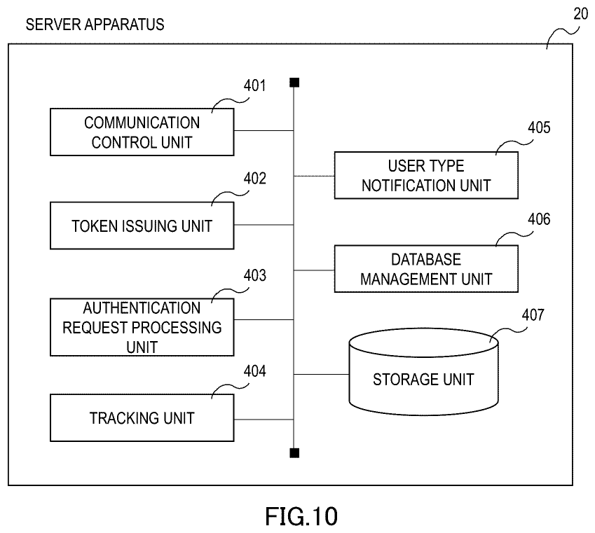

FIG. 10 is a diagram illustrating an example of a processing configuration (processing modules) of the server apparatus 20 according to the first example embodiment. Referring to FIG. 10, the server apparatus 20 includes a communication control unit 401, a token issuing unit 402, an authentication request processing unit 403, a tracking unit 404, a user type notification unit 405, a database management unit 406, and a storage unit 407.

The communication control unit 401 is means for controlling communication with other apparatuses. For example, the communication control unit 401 receives data (packets) from the check-in terminal 10, and so on. In addition, the communication control unit 401 transmits data to the check-in terminal 10, and so on. The communication control unit 401 gives data received from other apparatuses to other processing modules. The communication control unit 401 transmits data acquired from other processing modules to other apparatuses. In this way, other processing modules transmit and receive data to and from other apparatuses via the communication control unit 401. The communication control unit 401 includes a function as a receiving unit that receives data from other apparatuses and a function as a transmitting unit that transmits data to other apparatuses.

The token issuing unit 402 is means for issuing a token in response to a token issuance request from the check-in terminal 10. The token issuing unit 402 extracts a face image included in the token issuance request (a face image of a user who wishes to register with the system) and a face image included in the passport information. The token issuing unit 402 determines whether or not these two face images substantially match and performs an identity verification.

The token issuing unit 402 performs matching (one-to-one matching) between the above two face images. At that time, the token issuing unit 402 generates a feature value from each of the two images.

Note that since an existing technology can be used to generate the feature values, a detailed description thereof will be omitted. For example, the token issuing unit 402 extracts eyes, nose, mouth, and so on as feature points from the face image. After that, the token issuing unit 402 calculates the location of individual feature point and the distance between individual feature points as a feature value (generate a feature vector consisting of a plurality of feature values).

The token issuing unit 402 calculates the similarity of the two images based on the feature value, and determines whether the two images are face images of the same person or not based on a result of the threshold processing for the calculated similarity. Note that the chi-squared distance, the Euclidean distance, or the like can be used for the individual similarity. A longer distance represents a lower similarity, and a shorter distance represents a higher similarity.

For example, when the similarity is greater than a predetermined value (when the distance is shorter than a predetermined value), the token issuing unit 402 determines that the two face images indicate the same person (determines that the identity verification is successful). When the similarity is less than or equal to the predetermined value, the token issuing unit 402 determines that the two face images do not indicate the same person (determines that the identity verification fails).

When the identity verification is successful, the token issuing unit 402 issues a token. For example, the token issuing unit 402 generates a unique value as a token ID based on the date and time of processing, sequence number, and so on.

When the token issuing unit 402 generates the token (token ID), the token issuing unit 402 transmits a positive response (the token has been successfully issued) to the check-in terminal 10 that is the sender of the token issuance request. When the token issuing unit 402 fails to generate a token ID, the token issuing unit 402 transmits a negative response (the token has failed to be issued) to the check-in terminal 10 that is the sender of the token issuance request.

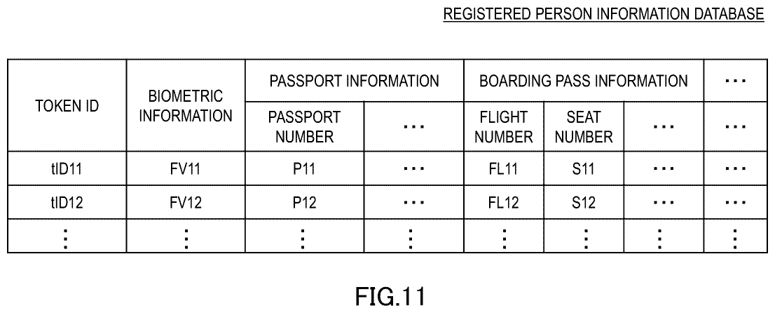

When the token issuing unit 402 succeeds in generating (issuing) the token ID, token issuing unit 402 registers the generated token ID, boarding pass information, passport information, and biometric information (feature value) in the registered person information database (see FIG. 11). Note that the registered person information database shown in FIG. 11 is an example, and is not intended to limit items to be stored. For example, a “face image” may be registered in the registered person information database as biometric information.

The authentication request processing unit 403 is means for processing an authentication request acquired from each authentication terminal, such as baggage drop machine 11 and boarding gate apparatus 14. The authentication request includes biometric information of the person to be authenticated. The authentication request processing unit 403 performs a matching processing (1-to-N matching; N is a positive integer, and the same applies to the following description) using biometric information included in the authentication request and the biometric information stored in the registered person information database.

The authentication request processing unit 403 generates a feature value from a face image acquired from the authentication terminal. The authentication request processing unit 403 sets the generated feature value (feature vector) as the feature value of matching side and feature value registered in the registered person information database as the feature value of the registration side, respectively.

The authentication request processing unit 403 determines that the matching processing has been successful when there exists a feature value whose similarity between the feature value among the plurality of feature values registered in the registered person information database and the feature value of the target to be matched is greater than a predetermined value.

When the authentication is successful, the authentication request processing unit 403 reads the operation information (passport information, boarding pass information, and so on) of the entry corresponding to the feature value with the highest similarity from the registered person information database.

The authentication request processing unit 403 transmits the result of authentication to the authentication terminal (responds to the authentication request). When the authentication is successful, the authentication request processing unit 403 transmits a positive response that includes that fact (authentication success) and the operation information to the authentication terminal. When the authentication fails, the authentication request processing unit 403 transmits a negative response that includes that fact (authentication failure) to the authentication terminal.

A tracking unit 404 is means for tracking users in the determination area as shown in FIG. 6. More specifically, the tracking unit 404 receives a video from the camera device 30 and determines a user type of at least one or more users who appear in an image that forms the video, and the user type regarding the method of procedure to be proceeded with the authentication terminal.

Furthermore, the tracking unit 404 tracks the user whose user type is determined using a video received from the camera device 30 as the target person to be tracked. That is, the tracking unit 404 grasps a location of the user (target person to be tracked) in real time by tracking using the video received from the camera device 30.

The tracking unit 404 stores the video (video formed from a plurality of image data) received from the camera device 30 in a buffer.

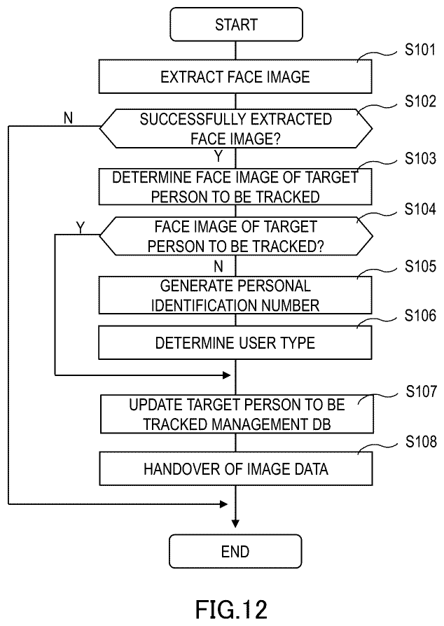

FIG. 12 is a flowchart illustrating an example of an operation of the tracking unit 404 according to the first example embodiment. Referring to FIG. 12, the operation of the tracking unit 404 will be described.

The tracking unit 404 attempts to extract a face image from the image in the buffer (one piece of still image data that forms video) (step S101).

When the tracking unit 404 fails to extract the face image (step S102, No branch), the tracking unit 404 does not perform any special processing.

When the tracking unit 404 successfully extracts at least one or more face images (step S102, Yes branch), the tracking unit 404 determines whether or not the face image is a face image of the target person to be tracked (step S103).

Specifically, when the tracking unit 404 can acquire the same face image as the face image of the target person to be tracked by performing conversion processing such as parallel translation, rotation, and scale on the extracted face image, the tracking unit 404 determines that the extracted face image is the face image of the target person to be tracked. When the tracking unit 404 cannot acquire such a face image, the tracking unit 404 determines that the extracted face image is not the face image of the target person to be tracked. Note that further description of the tracking processing using a face image will be omitted, since existing processing can be used.

When the extracted face image is not the face image of the target person to be tracked (step S104, No branch), the tracking unit 404 sets a person corresponding to the extracted face image to be the target person to be tracked. Specifically, the tracking unit 404 generates a “personal identification number” to identify the target person to be tracked (the face image of the target person to be tracked) (Step S105).

Note that the personal identification number may be any information as long as the personal identification number can uniquely identify the target person to be tracked. For example, the tracking unit 404 may assign a unique value to the personal identification number each time a new face image is extracted.

Next, the tracking unit 404 determines a type of the target person to be tracked (registered person in system, non-registered person in system) (determination of user type; step S106).

Specifically, the tracking unit 404 generates a feature value from the face image extracted from the image data, and performs a matching processing (1-to-N matching) using the generated feature value and a feature value stored in the registered person information database.

When the matching processing is successful (when biometric information that substantially matches the biometric information of the person in the image data is registered in the registered person information database), the tracking unit 404 determines that the target person to be tracked is the “registered person in system”.

When the matching processing fails (when biometric information that substantially matches the biometric information of the person in the image data is not registered in the registered person information database), the tracking unit 404 determines that the target person to be tracked is the “non-registered person in system”.

In this way, the tracking unit 404 determines the user type by the matching processing using the biometric information extracted from the image that forms the video and the biometric information stored in a passenger information database. More specifically, the tracking unit 404 determines whether the user is the registered person in system or the non-registered person in system as the user type. The system registered person in system is a user who can proceed with the procedure at the authentication terminal using biometric authentication by registering the biometric information of the user with the system. The non-registered person in system is a user who cannot proceed with the procedures at the authentication using biometric authentication.

After the user type is determined, the tracking unit 404 updates a target person to be tracked management database (DB; Data Base) (step S107).

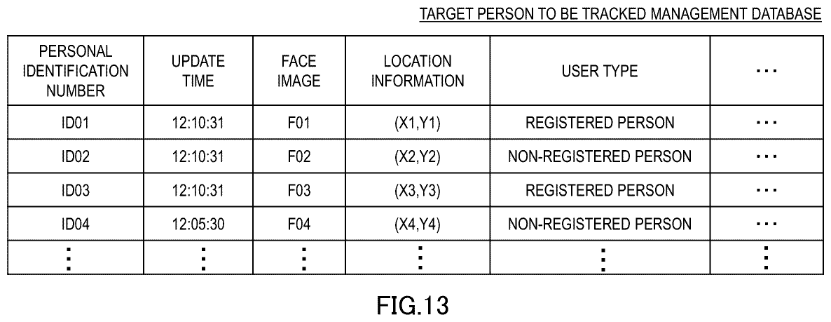

The target person to be tracked management database is a database for managing information on the target person to be tracked (see FIG. 13). Note that the target person to be tracked management database shown in FIG. 13 is an example, and is not intended to limit the items to be stored.

The tracking unit 404 adds a new entry to the target person to be tracked management database and stores the personal identification number, face image, location information, and user type (registered person in system, non-registered person in system), and so on, of the target person to be tracked in the entry. Note that the location information is a position from which the face image is extracted in the image coordinate system of the image data (for example, the X and Y coordinates of the center point of the face area).

Further, the tracking unit 404 stores the time at which the new entry is added to the target person to be tracked management database in the update time field.

When the extracted face image is the face image of the target person to be tracked (step S104, Yes branch), the tracking unit 404 updates the entry in the target person to be tracked management database using position information (X coordinate and Y coordinate of the image coordinate system) of the extracted face image (step S107).

More specifically, the tracking unit 404 rewrites a location information field of the entry that stores the face image of the target person to be tracked corresponding to the face image extracted from the image data with the location information of the extracted face image.

When the tracking unit 404 updates the location information of the target person to be tracked, the tracking unit 404 stores an update time (date and time of update) in an update time field of the corresponding entry.

The tracking unit 404 repeats the above processing for each face image extracted from one piece of image data. When the tracking unit 404 finishes the processing for each face image extracted from the image data, the tracking unit 404 hands over the processed image data to the user type notification unit 405 (handover of image data; step S108).

When the tracking unit 404 finishes the processing for one piece of image data, the tracking unit 404 performs the same processing for the next piece of image data stored in the buffer.

The user type notification unit 405 is means for notifying an external device of the user type of the target person to be tracked in the video received from the camera device 30. More specifically, the user type notification unit 405 reflects the user type in the video received from the camera device 30 and transmits the video in which the user type is reflected to the external device. At that time, the user type notification unit 405 reflects the user type in the video received from the camera device 30 by a method that enables a person to visually distinguish the user type.

In this way, the user type notification unit 405 notifies other device of the user type (registered person in system, non-registered person in system) of the user (target person to be tracked who has entered the determination area) in a manner that a person can visually grasp. More specifically, the user type notification unit 405 reflects the user type in the video captured by the camera device 30, so that the staff member in the procedure area can grasp the type of the user.

When the user type notification unit 405 acquires the image data from the tracking unit 404, the user type notification unit 405 accesses the target person to be tracked management database and acquires location information from each entry.

The user type notification unit 405 extracts the face image within a predetermined range centered on the coordinates corresponding to the location information. In other words, the user type identification unit 405 identifies the location of the target person to be tracked (the location of a face of the target person to be tracked) in the image data.

When the face image is successfully extracted, the user type notification unit 405 reads the user type corresponding to the location information from the target person to be tracked management database. The user type notification unit 405 modifies all or part of an image area of the above identified target person to be tracked, or a surrounding area of the image area, so that a person can visually confirm the read-out user type.

For example, the user type notification unit 405 sets a “frame” around the face area of the identified target person to be tracked in accordance with the user type. For example, the user type notification unit 405 writes a solid line frame around the face area of the registered person in system and a dotted line frame around the face area of the non-registered person in system.

Alternatively, the user type notification unit 405 may enable a person to visually distinguish the user type by using a color of the “frame” that is set around the face area of the identified target person to be tracked. For example, the user type notification unit 405 writes a red frame around the face area of the registered person in system and a blue frame around the face area of the non-registered person in system.

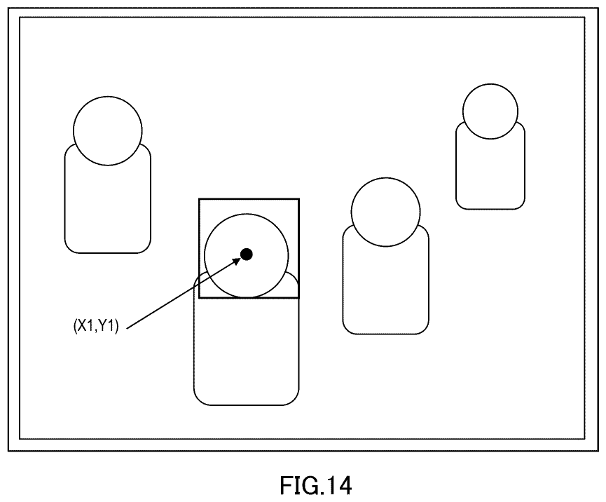

For example, when processing the entry for the first line in FIG. 13, the user type notification unit 405 attempts to extract the face image from around the location (X1, Y1) of the image data (see FIG. 14). When the face image is extracted, the user type notification unit 405 refers to a field of the user type in the target person to be tracked management database. In the example in FIG. 13, the user type is “registered person in system,” so the user type notification unit 405 writes a solid line frame around the face area corresponding to the location (X1, Y1) in the image data.

The user type notification unit 405 repeats the above processing for each entry in the target person to be tracked management database, and acquires the image data as shown in FIG. 7. In other words, the user type notification unit 405 generates the image data that reflects the user type (registered person in system, non-registered person in system) for each target person to be tracked who is moving through the determined area.

The user type notification unit 405 transmits the generated image data to the display device 40.

By having the tracking unit 404 and the user type notification unit 405 continuously repeat the above described processing for the video captured by the camera device 30, the display device 40 can output (play) the video that reflects the procedure selected by the user.

The database management unit 406 is means for managing the target person to be tracked management database. The database management unit 406 accesses the target person to be tracked management database periodically or at predetermined timing and deletes an entry that has not been updated for a predetermined period of time.

When a user exists in the determined area, the user is captured by the camera device 30 and a face image of the user is registered in the target person to be tracked management database as a face image of the target person to be tracked. Further, when the target person to be tracked moves, location information after the target person to be tracked has moved is reflected in the target person to be tracked management database by the tracking processing of the tracking unit 404. In this way, as long as the user exists in the determination area, the corresponding entry in the target person to be tracked management database is periodically updated. In other words, when the user leaves the determination area, the corresponding entry is not updated.

In this way, the database management unit 406 extracts the entry that has not been updated for a predetermined period of time and deletes the extracted entry (the personal identification number, face image, and so on are deleted).

Here, the face image of the user who has turned his or her back may temporarily not be extracted as the face image of the target person to be tracked because the user in the determination area has turned his or her back and so on. However, even in such a case, when the user exists in the determined area, a corresponding correct face image is extracted from the image data in a short period of time. Since the entry of the user who has turned his or her back is updated when the face image is extracted, the entry is not subject to deletion by the database management unit 406.

Note that it is possible that the face image of the user who has turned his or her back may be registered in the target person to be tracked management database as the face image of a new target person to be tracked. However, if the user does not continue to walk while turning his or her back, and the like, the entry for the user is deleted by the database management unit 406.

The storage unit 407 stores various kinds of information necessary for the operation of the server apparatus 20. The registered person information database and target person to be tracked management database are established in the storage unit 407. The passenger information database is a database that stores biometric information of the registered person in system.

### Camera Device

A detailed description of the camera device 30 will be omitted. This is because a configuration and an operation of the camera device 30 are obvious to those skilled in the art.

### Display Device

A detailed description of the display device 40 will be omitted. This is because a configuration and an operation of the display device 40 are obvious to a person skilled in the art. The display device 40 is a liquid crystal display or the like installed at the procedure area where the authentication terminal (for example, the boarding gate apparatus 14) is installed. The display device 40 corresponds to an external device from the perspective of the server apparatus 20.

### System Operation

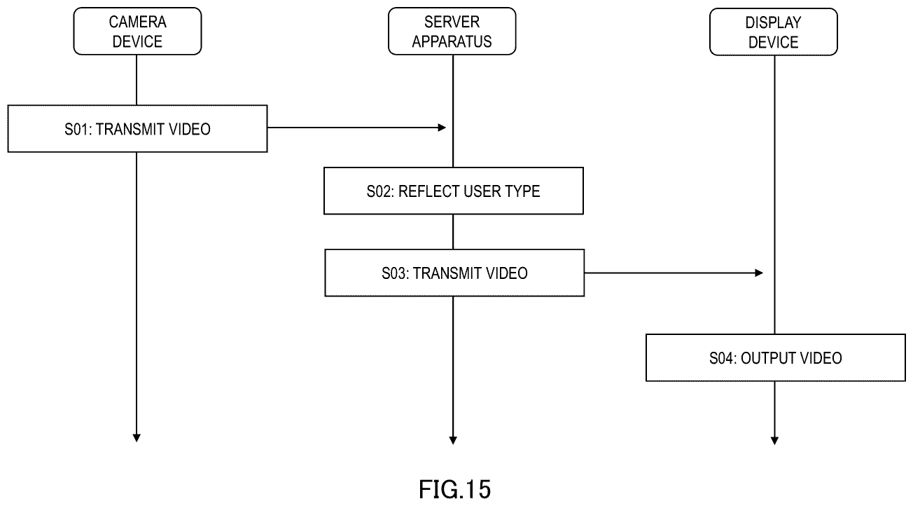

Next, an operation of the airport management system according to the first example embodiment will be described. FIG. 15 is a sequence diagram illustrating an example of the operation of the airport management system according to the first example embodiment. Referring to FIG. 15, an operation when a status of a procedure of a user (procedure using biometric authentication, procedure without using biometric authentication) is displayed on the display device 40 will be described.

The camera device 30 transmits a video to the server apparatus 20 (step S01).

The server apparatus 20 reflects a user type (registered person in system, non-registered person in system) of the target person to be tracked in the acquired video (Step S02).

The server apparatus 20 transmits the video reflecting the user type to the display device 40 (step S03).

The display device 40 outputs the received video (step S04).

### Variation 1 According to the First Example Embodiment

The above example embodiment describes a case in which a staff member 62 checks the video output by the display device 40 installed at the departure area and guides the user who attempts to line up in the wrong lane to the correct lane. In other words, the case in which the server apparatus 20 transmits the video (image data) to the display device 40 is described.

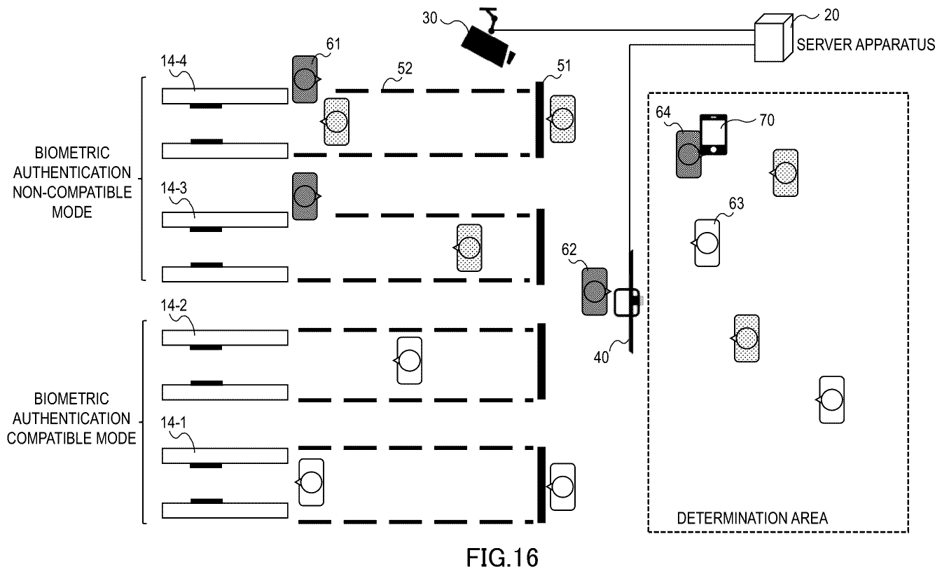

However, the server apparatus 20 may transmit the video to other device in addition to or instead of the display device 40. For example, the server apparatus 20 may transmit the video reflecting the user type for each user to a terminal 70 possessed by the staff member 64 shown in FIG. 16.

Examples of the terminal 70 include smartphones, tablets, or the like. A detailed description of a configuration or the like of the terminal 70 will be omitted. The terminal 70 is a terminal possessed by the staff member who provides the user with guidance regarding the procedure at the authentication terminal, and corresponds to an external device from the perspective of the server apparatus 20.

The staff member 64 provides guidance to the user while checking the video displayed on the terminal 70. By notifying the staff member who can move freely in the departure area of the user type, the staff member 64 can provide guidance to the user more reliably. In other words, the airline staff member can guide each user to the correct lane without missing any users, even if many users move to the departure area.

Moreover, as shown in FIG. 16, a plurality of staff members 62 and 64 can provide guidance to users while checking videos on different devices (the display device 40 and the terminal 70) to provide even more reliable guidance. For example, when the staff member 64 in front of the display device 40 fails to guide a user to the correct lane, the staff member 62 in the rear can guide the user to the correct lane.

### Variation 2 According to the First Example Embodiment

The above example embodiment describes a case when the server apparatus 20 notifies an airline staff member of the user type (category) of each user and the airline staff member guides the user who attempts to line up in the wrong lane to the correct lane.

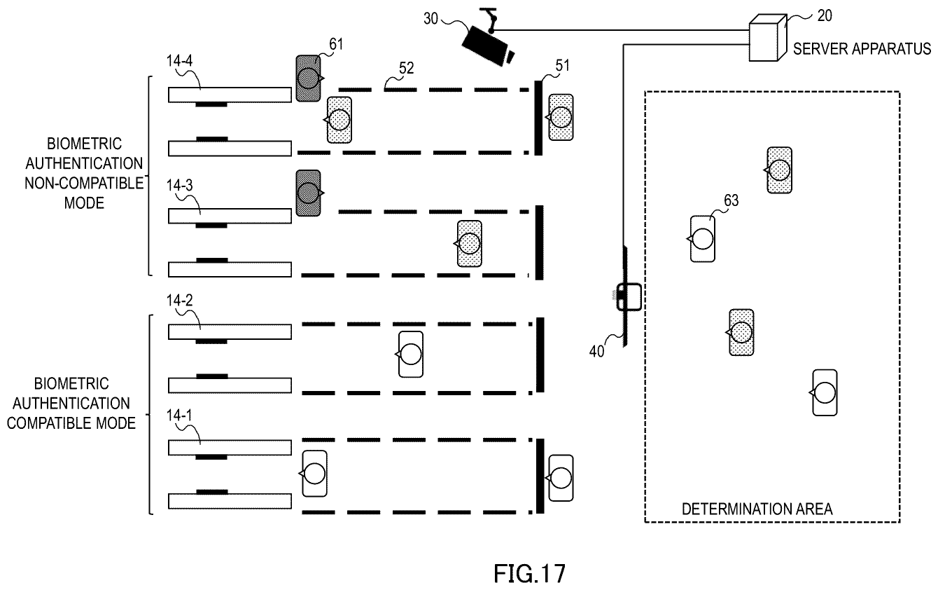

However, the server apparatus 20 may notify the user of the user type (registered person in system or non-registered person in system) for each user. That is, the user himself/herself may check the video displayed on the display device 40 and recognize the correct lane for the user. In this case, as shown in FIG. 17, the display device 40 may be installed so that the display device 40 catches the eye of users who have moved to the departure area. In FIG. 17, the display device 40 is installed in facing the opposite direction of the display device 40 in FIG. 6.

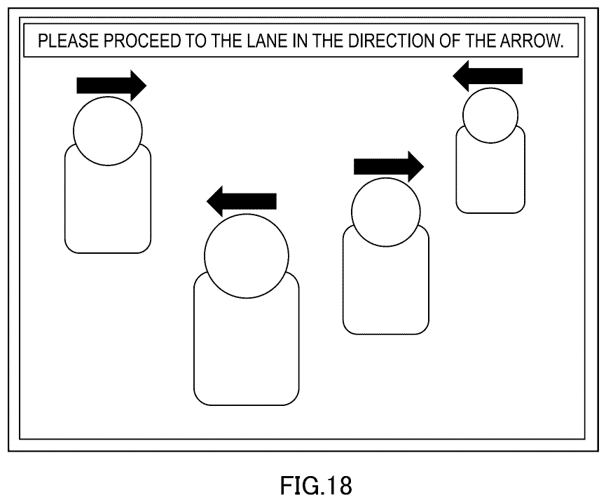

Furthermore, in order for the user himself/herself to recognize the correct lane, it is desirable that the server apparatus 20 display on the video a direction in which the user in the video should proceed. For example, the server apparatus 20 generates a video (image data) as shown in FIG. 18 and transmits the video to the display device 40. Note that in this case, information on the direction (lane) in which the registered person in system should proceed and the direction in which the non-registered person in system should proceed are set in the server apparatus 20 in advance. The server apparatus 20 can generate the video (image) as shown in FIG. 18 using the information. Note that the server apparatus 20 may display the number of the lane or gate to proceed to for each registered person in system and non-registered person in system, respectively, corresponding to each user.

The user can proceed to the correct lane by finding his or her own image in the video (image) on the display device 40 by checking an instruction (arrow) displayed in correspondence with his or her own image.

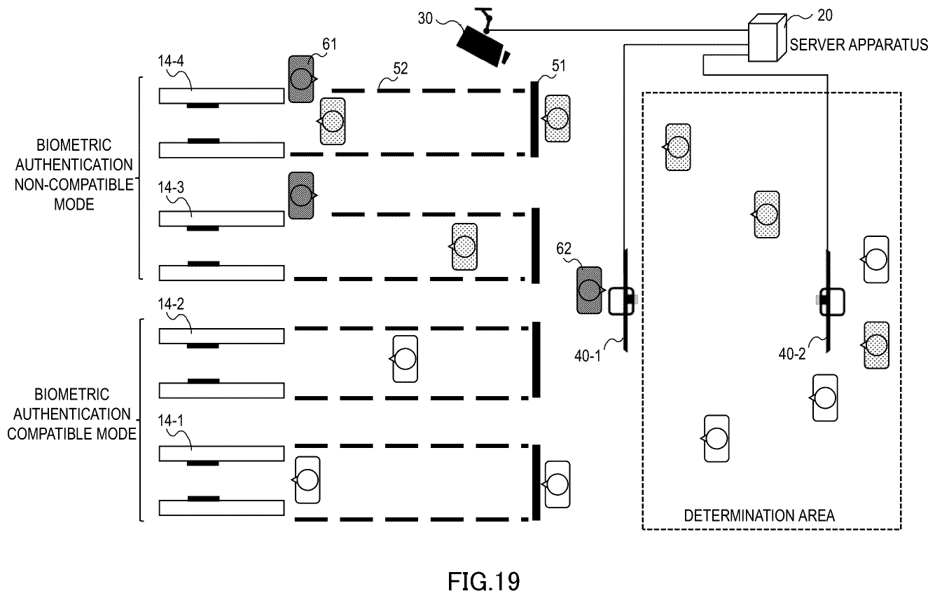

Alternatively, as shown in FIG. 19, a display device 40-1 checked by the airline staff member and a display device 40-2 checked by the user may be installed in the departure area. Most users check the video on the display device 40-2 and proceed to the correct lane. By checking the video output by the display device 40-1, the staff member 62 finds a user who attempts to proceed to the wrong lane for some reason, such as not checking the video output by the display device 40-2. The staff member 62 provides guidance to the user who is attempting to proceed to the wrong lane to the correct lane.

In this way, more reliable lane guidance can be achieved by installing the display devices 40-1 and 40-2 at the front and rear stages. Note that in this case, the server apparatus 20 may transmit a video such as that shown in FIG. 7 to the display device 40-1 and a video such as that shown in FIG. 18 to the display device 40-2, respectively.

Note that instead of the staff member 62 checking the video displayed on the display device 40-1 and guiding the user to the correct lane, the staff member 62 may have the terminal 70 and guide the user to the correct lane by checking the video displayed on the terminal 70.

As described above, the server apparatus 20 according to the first example embodiment performs a tracking processing on a user in the video acquired from the camera device 30 that captures an image of the determination area set in front of the authentication terminal. Further, when the server apparatus 20 extracts the target person to be tracked from the video, the server apparatus 20 identifies the type (type of procedure) of the target person to be tracked. The server apparatus 20 links the identified user type and the face image of the target person to be tracked via the personal identification number, and grasps the location information of the target person to be tracked in real time through the tracking processing. The server apparatus 20 generates the video reflecting the selection (procedure using biometric authentication, procedure without using biometric authentication) regarding the procedure of the target person to be tracked using the location information of the target person to be tracked that has been grasped in real time. The generated video is output to the display device 40 that is visible to the staff member of the airport company. The staff member checks the output video, finds the user who is heading to the wrong lane, and provides guidance to the user to the correct lane. As a result, each user can perform the procedure at the authentication terminal that matches the method of procedure he or she has selected, thereby reducing failed procedures in the procedure at the authentication terminal. Since failed procedures at the authentication terminal in the procedure area is reduced, throughput in the procedure area is improved.

In recent years, airports have begun to use biometric authentication for boarding procedures (for example, biometric authentication procedures at ABGs (Automated Border Gates)). At the ABG (boarding gate apparatus 14), users who have completed token registration (registration of biometric information) and users who have not completed token registration, and the like, arrive for the procedure. In addition to the biometric authentication compatible mode supporting the biometric authentication, the ABG has a boarding pass mode that determines whether or not a user who has not completed token registration can pass through (determine whether or not a user can pass through with a boarding pass). Currently, each of the ABGs installed at the boarding gate is assigned and set to one of the above modes, and the airline staff member asks the users to line up by saying, “Please line up in this row if you have completed face registration.” However, among users who have not completed token registration, there are some users who line up in the ABG lane in the biometric authentication compatible mode due to curiosity or misunderstanding. When the boarding process begins in this state, authentication failures frequently occur in the lane that should allow smooth boarding (the ABG lane that is compatible with biometric authentication; so-called face pass lane), resulting in a problem where efficient boarding utilizing biometric authentication is not being achieved. Due to these circumstances, there is a need to have only users who have completed token registration line up in the ABG lanes in biometric authentication compatible mode at lining up stage before the gate opens. Therefore, the server apparatus 20 of the present application meets the above needs by determining the user type and providing the staff member with a video that reflects the user type determined by the server apparatus 20.

### Second Example Embodiment

Next, a second example embodiment will be described in detail with reference to drawings.

The first example embodiment describes that the server apparatus 20 generates a video reflecting the user type (registered person in system, non-registered person in system) and transmits the generated video to the display device 40.

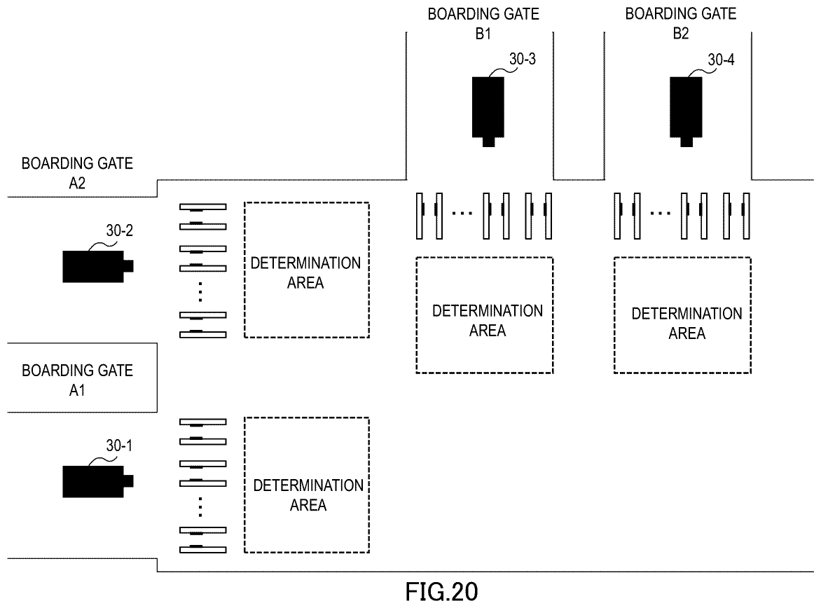

Here, there are plurality of boarding gates in the departure area, and at each of the boarding gates, an airline of a departing aircraft confirms boarding of the user. Specifically, as shown in FIG. 20, camera devices 30-1 to 30-4 are installed at each of the boarding gates so that the camera devices 30-1 to 30-4 can capture an image in front of each of the boarding gates. Each camera device 30 captures an image of the user moving in the determination area in front of each camera device 30 and transmits the acquired video (image) to the server apparatus 20.

As shown in FIG. 20, there are a plurality of boarding gates in the departure area, and a user needs to board an aircraft through the correct boarding gate. In other words, even if the registered person in system who is not eligible to board the aircraft lines up in a lane of the boarding gate apparatus 14 that is compatible with biometric authentication, he or she will not be permitted to pass through the boarding gate apparatus 14 of the wrong boarding gate.

The first example embodiment cannot deal with such a problem. For example, in FIG. 20, consider the case where the registered person in system who needs to board the aircraft from the boarding gate A2 mistakenly passes through the determination area corresponding to the boarding gate A1 and arrives at the boarding gate apparatus 14 installed in front of the boarding gate A1 (the boarding gate apparatus 14 that is compatible with biometric authentication).

In this case, since the user is definitely the “registered person in system,” the staff member providing guidance to users at the boarding gate A1 cannot know that the user is unable to pass through the boarding gate apparatus 14. The user is determined to be ineligible to board the aircraft at the boarding gate apparatus 14 and will be refused to pass through. However, the presence of such users will cause a decrease in the throughput of the boarding gate apparatus 14 and the user will feel embarrassed that he or she cannot pass through the boarding gate apparatus 14.

The second example embodiment describes a case in which a server apparatus 20 determines in advance whether or not the registered person in system can pass through the boarding gate apparatus 14, and transmits a video reflecting the result of determination to the display device 40.

As the airport management system according to the second example embodiment can have the same configuration as that according to the first example embodiment, the description corresponding to FIG. 3 will be omitted. In addition, as a processing configuration of each terminal (check-in terminal 10, baggage drop machine 11, and so on) and the server apparatus 20 according to the second example embodiment can have the same processing configurations as those according to the first example embodiment, description thereof will be omitted.

The following description will be made with a focus on the difference between the first example embodiment and the second example embodiment.

When the camera device 30 transmits a video to the server apparatus 20, the camera device 30 also transmits its own identification information to the server apparatus 20. Specifically, the camera device 30 transmits the video along with a camera ID to the server apparatus 20.

The camera ID is an ID to identify the camera device 30 installed at each boarding gate. A MAC (Media Access Control) address or IP (Internet Protocol) address of the camera device 30 can be used as the camera ID.

Note that the camera ID is shared between the server apparatus 20 and the camera device 30 by an arbitrary method. For example, a system administrator determines the camera ID and sets the determined camera ID in the server apparatus 20 and the camera device 30.

The server apparatus 20 acquires the video (a plurality of image data) from the camera device 30 and attempts to extract a face image from the image data. When the extracted face image is not a face image of the target person to be tracked, the tracking unit 404 determines the user type of the target person to be tracked (step S106 in FIG. 12).

When the user is determined to be the registered person in system in the user type determination, the tracking unit 404 determines whether or not the registered person in system can pass through the boarding gate apparatus 14 installed beyond the determination area.

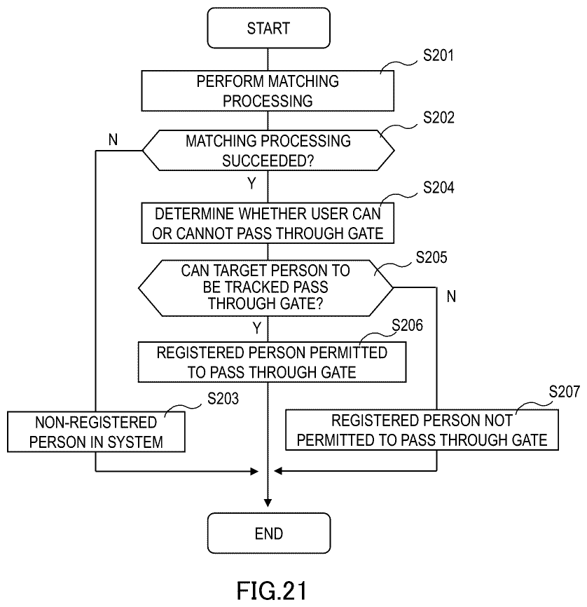

FIG. 21 is a flowchart illustrating an example of an operation of a tracking unit 404 according to the first example embodiment. Referring to FIG. 21, the operation related to the user type determination of the tracking unit 404 according to the second example embodiment will be described.

The tracking unit 404 performs a matching processing using biometric information (face image) extracted from the image data and biometric information registered in the passenger information database (step S201).

When the matching processing fails (step S202, No branch), the tracking unit 404 determines that the user (target person to be tracked) is the “non-registered person in system” (step S203).

When the matching processing is successful (step S202, Yes branch), the tracking unit 404 determines whether the registered person in system is allowed to pass through the boarding gate apparatus 14 or not (determining whether a user can or cannot pass through a gate: step S204).

Specifically, the tracking unit 404 reads boarding pass information (airline code, flight number, and so on) of the user who is determined to be the registered person in system from the passenger information database. In addition, based on the camera ID acquired from camera device 30, the tracking unit 404 acquires a boarding gate corresponding to the processed image data and information of a boarding pass (airline code and flight number) that the boarding gate apparatus 14 installed at the boarding gate permitting to board.

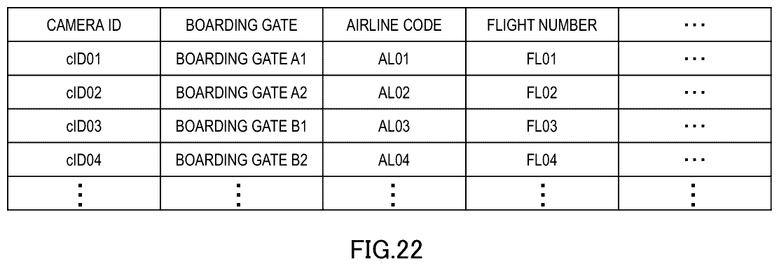

For example, the tracking unit 404 refers to the table information as shown in FIG. 22 and acquires an airline code and flight number that the boarding gate apparatus 14 has determined to be permitted to board from the camera ID. Note that each time the aircraft departing from each boarding gate changes, the staff member of the airport company, or the like, sets a new airline code, flight number, and so on in the table information shown in FIG. 22. Alternatively, the server apparatus 20 may acquire information equivalent to FIG. 22 from the DCS.

The tracking unit 404 compares the boarding pass information (airline code and flight number) read from the registered person information database with the boarding pass information (airline code and flight number) that is determined to be permitted to board based on the camera ID.

When the two pieces of information match, the tracking unit 404 determines that the user (target person to be tracked) can pass through the boarding gate apparatus 14 ahead. When the two pieces of information do not match, the tracking unit 404 determines that the user (target person to be tracked) cannot pass through the boarding gate apparatus 14 ahead.

When the target person to be tracked can pass through the gate (step S205, Yes branch), the tracking unit 404 determines that the user (target person to be tracked) is a “registered person permitted to pass through gate (registered person permitted to pass through)” (step S206).

When the target person to be tracked cannot pass through the gate (Step S205, No branch), the tracking unit 404 determines that the user (target person to be tracked) is a “registered person not permitted to pass through gate (registered person not permitted to pass through)” (Step S207).

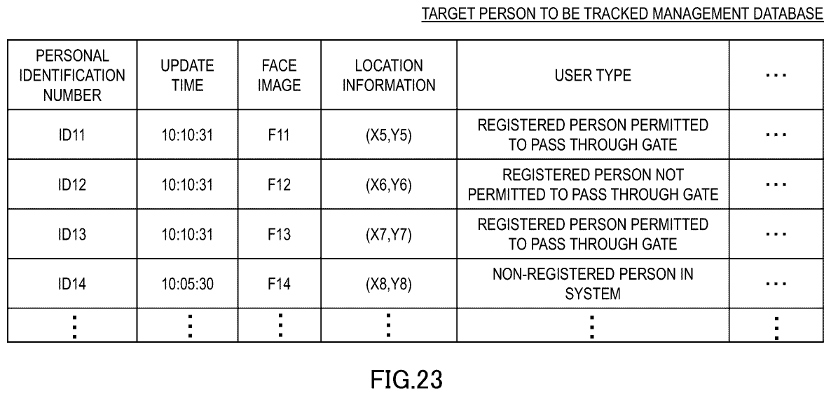

When the result of determination of user type is acquired, the tracking unit 404 reflects the result in the target person to be tracked management database (step S107 in FIG. 12). As a result, the target person to be tracked management database shown in FIG. 23 is acquired.

The user type notification unit 405 refers to the user type field in the tracking target person management database and acquires the type of each user (registered person permitted to pass through gate, registered person not permitted to pass through gate, or non-registered person in system) that appears in image data. The user type notification unit 405 processes the image data in a manner that allows the airline staff member (or user) to visually grasp the user type (the above three results of determination).

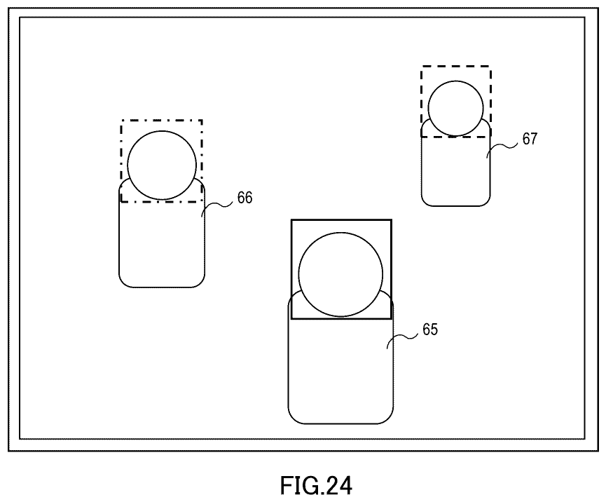

For example, the user type notification unit 405 generates the video (image) shown in FIG. 24. In FIG. 24, a user 65 is a “registered person permitted to pass through gate,” a user 66 is a “registered person not permitted to pass through gate,” and user 67 is a “non-registered person in system”.

As shown in FIG. 24, the user type notification unit 405 may change a line type (solid line, single-pointed line, or dotted line in the example in FIG. 24) of a “frame” set around the face area of the target person to be tracked in accordance with the user type of the target person to be tracked. Alternatively, the user type notification unit 405 may change a color of the “frame” set around the face area of the target person to be tracked in accordance with the user type of the target person to be tracked.

Alternatively, in order to make the “registered person not permitted to pass through gate” easier to find, the tracking unit 404 may display text such as “non-registered person” or “not permitted to pass through gate” or a symbol such as “X” around the face area of the registered person not permitted to pass through gate.

### Variation According to the Second Example Embodiment

When the server apparatus 20 reflects the user type of the target person to be tracked in the video, the server apparatus 20 may write the boarding gate to which the target person is heading into the video when the target person to be tracked is the “registered person not permitted to pass through gate”.

In this case, the user type notification unit 405 acquires the airline code and flight number of the aircraft that the target person to be tracked can board based on the boarding pass information acquired from the operation information of the target person to be tracked. The user type notification unit 405 acquires the boarding gate corresponding to the acquired airline code and flight number by referring to the table information shown in FIG. 22.

For example, consider the case when a user heading to the boarding gate A1 shown in FIG. 20 is the “registered person not permitted to pass through gate” and the correct boarding gate to which the user should be heading is the boarding gate A2. In this case, referring to FIG. 22, the airline code acquired from the boarding pass information of the registered person not permitted to pass through gate is “AL02” and the flight number is “FL02,” so the user type notification unit 405 acquires the boarding gate A2.

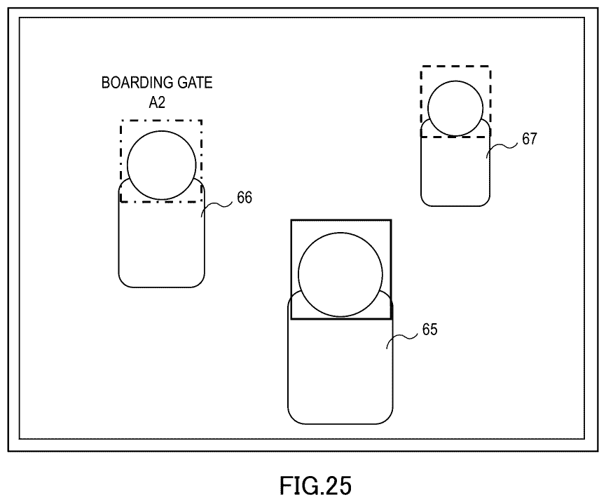

The user type notification unit 405 generates a video that reflects the above acquired boarding gate. For example, the user type notification unit 405 generates the video (image) shown in FIG. 25. The user type notification unit 405 transmits the video in which the boarding gate to which the registered person not permitted to pass through gate is heading is written to the display device 40.

The staff member who sees the video (image) as shown in FIG. 25 recognizes that the user 66 cannot pass through the boarding gate apparatus 14 installed at the boarding gate A1, and also recognizes that the user is a user who uses the boarding gate A2. Therefore, the staff member provides guidance to the user 66 to head to the boarding gate A2.

Note that in the second example embodiment, as in Variation 1 according to the first example embodiment, the server apparatus 20 may transmit the generated video to the terminal 70 possessed by the staff member. Alternatively, the server apparatus 20 may transmit the video to the display device 40 or the display device 40-2 that is installed so that the user can see the display device 40 or the display device 40-2, as shown in FIGS. 17 and 19.

As described above, when the user is the registered person in system, the server apparatus 20 of the second example embodiment determines, as the user type, whether the user is the registered person permitted to pass through who is successfully authenticated at the authentication terminal, or whether the user is the registered person not permitted to pass through who fails to authenticate at the authentication terminal. The server apparatus 20 transmits the video that reflects the result of determination to the display device 40 and the terminal 70. By checking the video output by the display device 40 and so on, the staff member can find the user who is heading to the wrong boarding gate and stop the user from heading to the wrong boarding gate. As a result, throughput of the boarding gate apparatus 14 is prevented from decreasing.

Furthermore, the server apparatus 20 reflects information regarding the location where the registered person not permitted to pass through gate will be determined to be successfully authenticated (for example, the number of the boarding gate to which the person not permitted to pass through gate should head) in the video received from the camera device 30. The server apparatus 20 transmits the video to the display device 40, and so on. The staff member who sees the video output by the display device 40 can find the user who is heading to the wrong boarding gate and can provide accurate guidance because the staff member knows the boarding gate to which the user heads. As a result, the throughput of the boarding gate apparatus 14 is prevented from decreasing and better service is provided to users.

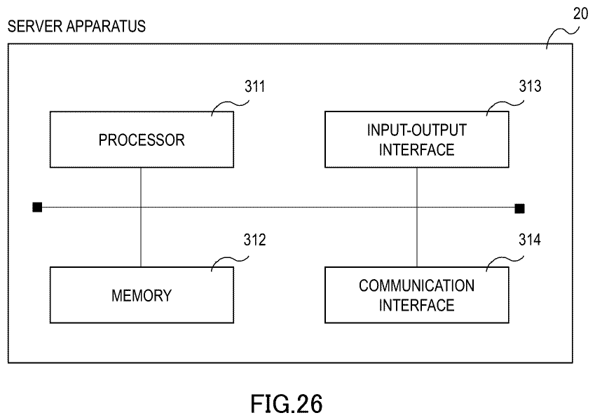

Next, a hardware configuration of an individual apparatus that constitutes the airport management system will be described. FIG. 26 is a diagram illustrating an example of a hardware configuration of the server apparatus 20.

The server apparatus 20 can be configured by an information processing apparatus (a so-called computer) and includes a configuration illustrated as an example in FIG. 26. For example, the server apparatus 20 includes a processor 311, a memory 312, an input-output interface 313, a communication interface 314, and so on. The components such as the processor 311 are connected to an internal bus, and so on so that these components can communicate with each other.

The hardware configuration of the server apparatus 20 is not limited to the configuration illustrated in FIG. 26. The server apparatus 20 may include hardware not illustrated or may be configured without the input-output interface 313 if desired. In addition, the number of components, such as the number of processors 311, included in the server apparatus 20 is not limited to the example illustrated in FIG. 26. For example, a plurality of processors 311 may be included in the server apparatus 20.

For example, the processor 311 is a programmable device such as a CPU (Central Processing Unit), an MPU (Micro Processing Unit), or a DSP (Digital Signal Processor). Alternatively, the processor 311 may be a device such as an FPGA (Field Programmable Gate Array) or an ASIC (Application Specific Integrated Circuit). The processor 311 executes various kinds of programs including an operating system (OS).

The memory 312 is a RAM (Random Access Memory), a ROM (Read-Only Memory), an HDD (Hard Disk Drive), an SSD (Solid State Drive), and so on. The memory 312 stores an OS program, an application program, and various kinds of data.

The input-output interface 313 is an interface for a display device and an input apparatus not illustrated. For example, the display device is a liquid crystal display and so on. For example, the input apparatus is an apparatus that receives user operations, and examples of the input apparatus include a keyboard and a mouse.

The communication interface 314 is a circuit, a module, and so on for performing communication with other apparatuses. For example, the communication interface 314 includes a NIC (Network Interface Card) and so on.

The function of the server apparatus 20 is realized by various kinds of processing modules. The processing modules are realized, for example, by causing the processor 311 to execute a program stored in the memory 312. In addition, this program can be recorded in a computer-readable storage medium. The storage medium may be a non-transient (non-transitory) storage medium, such as a semiconductor memory, a hard disk, a magnetic recording medium, or an optical recording medium. That is, the present invention can be embodied as a computer program product. In addition, the above program may be updated by downloading a program via a network or by using a storage medium in which a program is stored. In addition, the above processing modules may be realized by semiconductor chips.

As is the case with the server apparatus 20, the check-in terminal 10, and so on can be configured by an information processing apparatus, and the basic hardware configuration of the check-in terminal 10 is the same as that of the server apparatus 20. Thus, description of the basic hardware configuration of the check-in terminal 10 will be omitted.

The server apparatus 20 which is an information processing device includes a computer and can realize its functions by causing the computer to execute a program. In addition, the server apparatus 20 executes a control method of the server apparatus 20 by using this program.

### Variations

The configurations, operations, or the like of the airport management system according to the above example embodiments are examples and do not limit the present system configuration, and so on.

In the above example embodiments, the operation of the information processing system of the present application is described using procedures at an airport as an example. However, it is not intended to limit the application of the information processing system of the present application to procedures in airports. The information processing system of the present application can be applied to procedures at other facilities and the like. For example, the information processing system of the present application can be applied to admission control at an event venue where persons who have purchased electronic tickets and persons who have purchased paper tickets are mixed. In this case, a user who has purchased an electronic ticket passes through a gate that is compatible with biometric authentication, while a user who has purchased a paper ticket passes through the gate by presenting the paper ticket to a staff member. The server apparatus 20 can reflect the user type (electronic ticket purchaser, paper ticket purchaser) in a video (image) acquired from the camera device 30 and provide a guidance staff with the video.

The above example embodiments describe a case in which the information processing system of the present application is applied to procedures in the departure area in an airport. However, the information processing system can also be applied to other procedure areas. For example, a video may be generated that reflects a user who can pass through the authentication terminal (the gate apparatus 13) installed at the emigration inspection area with biometric authentication and a user who cannot pass through the authentication terminal with biometric authentication (a user who needs to be examined by the emigration and immigration inspector). At the emigration inspection area, the staff member of the airport company, or the like may check the video and guide the user who is heading to a wrong location for procedure to a correct location for procedure.

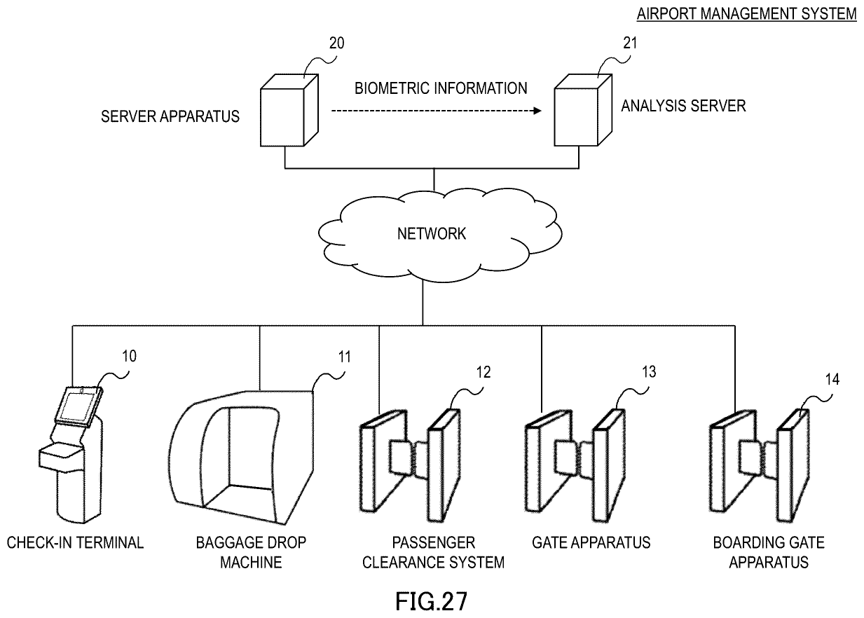

The above example embodiments describe that the server apparatus 20 generates a token for a user to proceed with a procedure with biometric authentication and tracks the user in a procedure area by analyzing video data acquired from the camera device 30. However, in the airport management system of the present application, the operations included in the above server apparatus 20 may be separated and implemented in different servers from each other. Specifically, the server apparatus 20 realizes functions related to token generation and biometric authentication. Furthermore, the airport management system includes an analysis server 21 (see FIG. 27). The analysis server 21 realizes a function of analysis of video (the tracking unit 404 and the user type notification unit 405) of the server apparatus 20 described above. In other words, the analysis server 21 receives a video from the camera device 30, reflects the user type (registered person in system, non-registered person in system, or the like) on the received video in real time, and transmits the video to the display device 40. Note that contents of the registered person information database (information such as biometric information) included in the server apparatus 20 are duplicated from the server apparatus 20 to the analysis server 21 as necessary. For example, the contents of the registered person information database are input to the analysis server 21 using an external storage medium such as a USB (Universal Serial Bus). Note that since the analysis server 21 only needs to include processing modules such as the tracking unit 404 and user type notification unit 405 described above, further detailed description will be omitted.

The above example embodiments describe a case in which the user type is reflected in the movie acquired from a single camera device 30. However, the server apparatus 20 may reflect the user type in each video acquired from a plurality of camera devices 30 and transmit the video that reflects the user type to the display device 40. At that time, the server apparatus 20 may transmit the video to the display device 40 corresponding to each camera device 30, or may transmit a video selected from among a plurality of videos to the display device 40. For example, the server apparatus 20 may select and transmit to the display device 40 a video that shows a large number of users or a video that shows the registered person not permitted to pass through gate from among a plurality of videos.

The camera device 30 does not need to be a camera fixed to a ceiling or the like in the procedure area. For example, the server apparatus 20 may acquire a video from a camera included in the display device 40. In this case, the display device 40 is equipped with a camera that can capture an image of a user walking toward the display device 40.

Alternatively, the server apparatus 20 may receive a video from the terminal 70 possessed by an airline staff member or the like. The staff member may acquire the user type of a user from the server apparatus 20 by operating the terminal 70 and capturing an image of the user whose user type he or she wishes to know, and may provide any necessary guidance.

The above example embodiments describe that the boarding gate apparatus 14 can switch between the biometric authentication compatible mode and the biometric authentication non-compatible mode. Furthermore, it is described that in the biometric authentication non-compatible mode, the staff member reads the boarding pass into the boarding gate apparatus 14, and the boarding gate apparatus 14 controls the passage of the user based on the boarding pass that has been read. Here, the biometric authentication non-compatible mode also includes other modes other than those mentioned above. For example, a bypass mode that takes into consideration a user in a wheelchair, and so on, and a self-mode in which the user himself/herself reads his/her passport and boarding pass into the boarding gate apparatus 14 are also included in the biometric authentication non-compatible mode. In the bypass mode, the boarding gate apparatus 14 does not control the gate (flapper). The staff member determines whether the user is permitted to pass through the gate or not. Furthermore, in the self-mode, the boarding gate apparatus 14 performs identity verification using a face image described in the passport and a face image acquired by capturing an image of the user, and when the identity verification is successful, the boarding gate apparatus 14 determines whether the user is permitted to pass through the gate based on information on the read boarding pass. In this way, various modes are included in the biometric authentication non-compatible mode. In consideration of the above, the biometric authentication compatible mode corresponds to a walk-through mode, in which a user who can pass through the gate in the walk-through manner. On the other hand, the biometric authentication non-compatible mode corresponds to a non-walk-through mode in which a user should stop at the gate and complete a procedure, even if the user is able to pass through the gate.

The above example embodiments describe setting a “frame” on the face area of the video or changing the color of the “frame” in order to enable the staff member, or the like, to grasp the user type. However, the server apparatus 20 can notify the staff member of the user type using any other method. For example, the server apparatus 20 may surround a whole body of the user in the video with a frame or change the color of the frame surrounding the whole body. Alternatively, the server apparatus 20 may blink and so on the frames set in a face area or a whole body area. Alternatively, the server apparatus 20 may replace the face area and the whole body area of the user in the video with a face image of a character or the like in accordance with the user type.

The above example embodiments describe that the server apparatus 20 generates a video with the same frame rate as the video received from the camera device 30 and transmits the video to the display device 40. However, the server apparatus 20 (the user type notification unit 405) may transmit a video with a reduced frame rate to the display device 40, as needed. For example, the server apparatus 20 may convert a video of 30 fps (frames per second) to a video of 5 fps and transmit the video to the display device 40 in order to secure processing time for tracking processing and determination processing of the user type.

As shown in FIG. 17 and FIG. 19, when the user type is notified to each user, the user type may be notified to the user by other means in addition to or instead of a notification by a video. For example, the server apparatus 20 may use a highly directional parametric speaker to notify each user of a lane in which the user should proceed. Alternatively, the server apparatus 20 may display the user type and the lane in which the user should proceed under the feet of the user using a technology such as a projection mapping.

The above example embodiments describe a case in which the authentication terminal (for example, the boarding gate apparatus 14) determines whether or not a user is permitted to pass through the gate. However, the server apparatus 20 may also perform the determination. For example, regarding whether or not the user is permitted to pass through the boarding gate apparatus 14, the server apparatus 20 may determine whether or not the user is permitted to pass through the boarding gate apparatus 14 based on the boarding pass information of the user and information (airline code, flight number, and the like) set in the boarding gate apparatus 14. The server apparatus 20 may set the result of the authentication processing (authentication success, authentication failure) based on the result of determination.

The above example embodiments describe a case in which biometric information related to a face image is transmitted and received between the apparatuses. However, a feature value generated from the face image may also be transmitted and received between the apparatuses. In this case, the server apparatus 20 on the receiving side may use the received feature value and utilize the received feature value in subsequent processing. Alternatively, biometric information stored in the registered person information database may be a feature value or a face image. When the face image is stored, the feature value may be generated from the face image as needed. Alternatively, both the face image and the feature value may be stored in the registered person information database.

The above example embodiment describes a case in which the registered person information database and the target person to be tracked management database are configured inside the server apparatus 20, but these databases may be established in an external database server or the like. That is, some of the functions of the server apparatus 20 may be implemented in another server. More specifically, the “authentication request processing unit (authentication request processing means)”, “tracking unit (tracking means),” and so on described above may be implemented in any of the apparatuses included in the system.

While the data exchange between each apparatus (the server apparatus 20, the check-in terminal 10, and so on) is not limited to any particular mode, data exchanged between these apparatuses may be encrypted. It is desirable that the passport information, and so on are transmitted and received between these apparatuses and encrypted data is transmitted and received in order to properly protect this information.

In the flowcharts and sequence diagrams used in the above description, a plurality of steps (processes) are sequentially described. However, the order of the execution of the steps performed in the individual example embodiment is not limited to the described order. In the individual example embodiment, the order of the illustrated steps may be changed to the extent that a problem is not caused on the content of the individual example embodiment. For example, individual processes may be executed in parallel.

The above example embodiments have been described in detail to facilitate the understanding of the present application disclosed and not to mean that all the configurations described above are needed. In addition, if a plurality of example embodiments have been described, each of the example embodiments may be used individually or a plurality of example embodiments may be used in combination. For example, part of a configuration according to one example embodiment may be replaced by a configuration according to another example embodiment. For example, a configuration according to one example embodiment may be added to a configuration according to another example embodiment. In addition, addition, deletion, or replacement is possible between part of a configuration according to one example embodiment and another configuration.

The industrial applicability of the present invention has been made apparent by the above description. That is, the present invention is suitably applicable, for example, to airport management systems and the like regarding users who use aircraft and the like.

A part or the entirety of the example embodiments described above may be described as in the following supplementary notes, but is not limited to the followings.

### Supplementary Note 1

A server apparatus, including:
a tracking unit that receives a video from a camera device, determines a user type of at least one or more users, the user type regarding a method of procedure to be proceeded with at an authentication terminal, who appear in images that forms the video, and tracks a user whose the user type is determined using a video received from the camera device as a target person to be tracked; and
a notification unit that notifies an external device of the user type of the target person to be tracked who appears in the video received from the camera device.

### Supplementary Note 2

The server apparatus according to supplementary note 1, wherein the notification unit reflects the user type in the video received from the camera device and transmits the video in which the user type is reflected to the external device.

### Supplementary Note 3

The server apparatus according to supplementary note 2, wherein the notification unit reflects the user type in the video received from the camera device by a method that enables a person to visually distinguish the user type.

### Supplementary Note 4

The server apparatus according to any one of supplementary notes 1 to 3, wherein the tracking unit determines, as the user type, whether the user is a registered person in system who can proceed with the procedure at the authentication terminal using biometric authentication by registering biometric information of the user with the system, or whether a non-registered person in system who cannot proceed with the procedures at the authentication terminal using the biometric authentication.

### Supplementary Note 5

The server apparatus according to supplementary note 4, wherein, when the user is the registered person in system, the tracking unit determines, as the user type, whether the user is a registered person permitted to pass through who is successfully authenticated at the authentication terminal, or whether the user is a registered person not permitted to pass through who fails to authenticate at the authentication terminal.

### Supplementary Note 6

The server apparatus according to supplementary note 5, wherein the notification unit reflects information regarding a location where the registered person not permitted to pass through will be determined to be successfully authenticated in the video received from the camera device.

### Supplementary Note 7

The server apparatus according to supplementary note 4 or 5, wherein the notification unit makes the user type visually distinguishable by a person by using a color of a frame set around a face area of the target person to be tracked in the images that forms the video.

### Supplementary Note 8

The server apparatus according to any one of supplementary notes 1 to 7, wherein the external device is a display device installed at a procedure area where the authentication terminal is installed.

### Supplementary Note 9

The server apparatus according to any one of supplementary notes 1 to 7, wherein the external device is a terminal possessed by a staff member who provides the user with guidance regarding the procedure at the authentication terminal.

### Supplementary Note 10

The server apparatus according to any one of supplementary notes 1 to 9, further including a database that stores biometric information of the user, wherein the tracking unit determines the user type by a matching processing using biometric information extracted from the image and the biometric information stored in the database.

### Supplementary Note 11

The server apparatus according to supplementary note 10, wherein the biometric information is a face image or feature value extracted from the face image.

### Supplementary Note 12

A system, including:
a camera device; and
a server apparatus,
wherein the server apparatus includes:
a tracking unit that receives a video from the camera device, determines a user type of at least one or more users, the user type regarding a method of procedure to be proceeded with at an authentication terminal, who appear in images that forms the video, and tracks a user whose the user type is determined using a video received from the camera device as a target person to be tracked; and

a notification unit that notifies an external device of the user type of the target person to be tracked who appears in the video received from the camera device.

### Supplementary Note 13

A control method of a server apparatus, the control method including:
receiving a video from a camera device, determining a user type of at least one or more users, the user type regarding a method of procedure to be proceeded with at an authentication terminal, who appear in images that forms the video, and tracking a user whose the user type is determined using a video received from the camera device as a target person to be tracked; and
notifying an external device of the user type of the target person to be tracked who appears in the video received from the camera device.

### Supplementary Note 14

A computer-readable storage medium storing a program causing a computer mounted on a server apparatus to perform processing for:
receiving a video from a camera device, determining a user type of at least one or more users, the user type regarding a method of procedure to be proceeded with at an authentication terminal, who appear in images that forms the video, and tracking a user whose the user type is determined using a video received from the camera device as a target person to be tracked; and
notifying an external device of the user type of the target person to be tracked who appears in the video received from the camera device.

The entire disclosure of the above patent literature is incorporated herein by reference thereto. While the example embodiments of the present invention have thus been described, the present invention is not limited to these example embodiments. It is to be understood to those skilled in the art that these example embodiments are only examples and that various variations are possible without departing from the scope and sprit of the present invention. That is, the present invention of course includes various variations and modifications that could be made by those skilled in the art in accordance with the overall disclosure including the claims and the technical concept.

### Reference Signs List

10 check-in terminal
11 baggage drop machine
12 passenger clearance system
13 gate apparatus
14 boarding gate apparatus
14-1 boarding gate apparatus
14-2 boarding gate apparatus
14-3 boarding gate apparatus
14-4 boarding gate apparatus
20 server apparatus
21 analysis server
30 camera device
30-1 camera device
30-2 camera device
30-3 camera device
30-4 camera device
40 display device
40-1 display device
40-2 display device
51 stop line
52 fence
61 staff member
62 staff member
63 user
64 staff member
65 user
66 user
67 user
70 terminal
100 server apparatus
101 tracking unit
102 notification unit
201 communication control unit
202 check-in execution unit
203 system registration unit
204 message output unit
205 storage unit
301 mode control unit
302 communication control unit
303 biometric information acquisition unit
304 authentication request unit
305 function realization unit
306 storage unit
311 processor
312 memory
313 input-output interface
314 communication interface
401 communication control unit
402 token issuing unit
403 authentication request processing unit
404 tracking unit
405 user type notification unit
406 database management unit
407 storage unit

What is claimed is:

1. A server apparatus, comprising:
at least one memory storing a set of instructions; and
at least one processor configured to execute the set of instructions to:
receive a video from a camera device, determines a user type of at least one or more users, the user type regarding a method of procedure to be proceeded with at an authentication terminal, who appear in images that forms the video, and tracks a user whose the user type is determined using a video received from the camera device as a target person to be tracked; and
notify an external device of the user type of the target person to be tracked who appears in the video received from the camera device.

2. The server apparatus according to claim 1, wherein
the at least one processor is further configured to execute the set of instructions to:
reflect the user type in the video received from the camera device and transmit the video in which the user type is reflected to the external device.

3. The server apparatus according to claim 2, wherein
the at least one processor is further configured to execute the set of instructions to:
reflect the user type in the video received from the camera device by a method that enables a person to visually distinguish the user type.

4. The server apparatus according to claim 1, wherein
the at least one processor is further configured to execute the set of instructions to:
determine, as the user type, whether the user is a registered person in system who can proceed with the procedure at the authentication terminal using biometric authentication by registering biometric information of the user with the system, or whether a non-registered person in system who cannot proceed with the procedures at the authentication terminal using the biometric authentication.

5. The server apparatus according to claim 4, wherein
the at least one processor is further configured to execute the set of instructions to:
determines, as the user type, whether the user is a registered person permitted to pass through who is successfully authenticated at the authentication terminal, or whether the user is a registered person not permitted to pass through who fails to authenticate at the authentication terminal when the user is the registered person in system.

6. The server apparatus according to claim 5, wherein
the at least one processor is further configured to execute the set of instructions to:
reflect information regarding a location where the registered person not permitted to pass through will be determined to be successfully authenticated in the video received from the camera device.

7. The server apparatus according to claim 4, wherein
the at least one processor is further configured to execute the set of instructions to:
make the user type visually distinguishable by a person by using a color of a frame set around a face area of the target person to be tracked in the images that forms the video.

8. The server apparatus according to claim 1, wherein the external device is a display device installed at a procedure area where the authentication terminal is installed.

9. The server apparatus according to claim 1, wherein the external device is a terminal possessed by a staff member who provides the user with guidance regarding the procedure at the authentication terminal.

10. The server apparatus according to claim 1, further comprising a database that stores biometric information of the user, wherein
the at least one processor is further configured to execute the set of instructions to:
determine the user type by a matching processing using biometric information extracted from the image and the biometric information stored in the database.

11. The server apparatus according to claim 10, wherein the biometric information is a face image or feature value extracted from the face image.

12. A system, comprising:
a camera device; and
a server apparatus,
wherein the server apparatus comprises:
at least one memory storing a set of instructions; and
at least one processor configured to execute the set of instructions to:
receive a video from the camera device, determines a user type of at least one or more users, the user type regarding a method of procedure to be proceeded with at an authentication terminal, who appear in images that forms the video, and tracks a user whose the user type is determined using a video received from the camera device as a target person to be tracked; and
notify an external device of the user type of the target person to be tracked who appears in the video received from the camera device.

13. A control method of a server apparatus, the control method comprising:
receiving a video from a camera device, determining a user type of at least one or more users, the user type regarding a method of procedure to be proceeded with at an authentication terminal, who appear in images that forms the video, and tracking a user whose the user type is determined using a video received from the camera device as a target person to be tracked; and
notifying an external device of the user type of the target person to be tracked who appears in the video received from the camera device.

14. (canceled)
